(19) United States
(12) Patent Application Publication
(10) Pub. No.: US 2026/0289443 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/567,384

(22) Filed: Mar. 16, 2026

(30) Foreign Application Priority Data
Mar. 19, 2025 (JP) 2025-045079

(51) Int. Cl. G06Q 10/0631; G06F 40/169; G06F 40/253; G06F 40/284; G06F 40/295; G06F 40/40; G06N 3/0475

(52) U.S. Cl. CPC G06Q 10/063112; G06F 40/169; G06F 40/253; G06F 40/284; G06F 40/295; G06F 40/40; G06N 3/0475

(57) ABSTRACT

A system includes a processor that is configured to compare a previous-period objective with current performance data and calculate at least one of a growth rate and an achievement rate, acquire user skill set information and career path information and set a qualitative objective aimed at self-development based on the user skill set information and the career path information, acquire legal information related to a business operation and set an objective that takes legal compliance into account based on the legal information, integrate a numerical objective, the qualitative objective, and a legal compliance objective and generate a prompt text for automatically generating a management by objectives (MBO) draft objective using a generative artificial intelligence model, and analyze an emotional state of a user and adjust at least one of the numerical objective and the qualitative objective based on the emotional state of the user.

### CROSS-REFERENCE TO RELATED APPLICATION

This application is based on and claims priority under 35 USC 119 from Japanese Patent Application No. 2025-045079 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional management by objectives (MBO) systems typically rely on manual goal-setting processes in which managers and employees define numerical, qualitative, and compliance-related goals through meetings or by filling out static templates. Such approaches suffer from several problems. First, numerical goals are often set without systematic comparison between previous-period objectives and current performance data, which can lead to goals that are either unrealistic or insufficiently challenging. Second, qualitative objectives related to self-development are frequently generic and not tailored to each user's specific skill set, career path, or performance evaluation, resulting in low effectiveness in promoting meaningful self-improvement. Third, objectives that take legal and regulatory compliance into account are often omitted or inconsistently defined, because they require specialized knowledge of applicable laws and internal rules. Fourth, even when generative artificial intelligence (AI) is introduced to draft MBO objectives, the prompts given to the AI are frequently ad hoc and not derived from a structured integration of numerical, qualitative, and compliance-related information, leading to inconsistent quality of the generated MBO drafts. Fifth, conventional systems rarely consider the emotional state of the user during goal setting; as a result, goals may not be appropriately calibrated to the user's current motivation or stress level, which can reduce engagement and adherence. Moreover, existing systems generally do not provide a mechanism for dynamically adjusting automatically generated MBO objectives in response to both user dialogue and real-time emotional analysis. Accordingly, there is a need for a system that systematically computes numerical objectives from past and current data, generates tailored qualitative self-development objectives, sets compliance-conscious objectives based on legal information, constructs high-quality prompts for a generative AI model, and adjusts objectives dynamically by analyzing the user's emotional state and interactive feedback.

### SUMMARY

In order to solve the above-described problems, the present invention provides a system comprising a processor, wherein the processor is configured to compare a previous-period objective with current performance data and calculate at least one of a growth rate and an achievement rate. By executing such comparison and calculation, the processor can derive a numerical objective that reflects objective past performance trends rather than arbitrary manual input. The processor is further configured to acquire user skill set information and career path information and to set a qualitative objective aimed at self-development based on the user skill set information and the career path information, thereby enabling generation of qualitative goals that are specifically tailored to the user's current capabilities and future role expectations. In addition, the processor is configured to acquire legal information related to a business operation and to set an objective that takes legal compliance into account based on this legal information, so that the system can automatically embed compliance requirements into the MBO structure without relying solely on the user's legal knowledge. The processor is also configured to integrate a numerical objective, the qualitative objective, and a legal compliance objective and to generate a prompt text for automatically generating a management by objectives draft objective using a generative artificial intelligence model. Through this integration, the processor constructs a rich, structured prompt that allows the generative AI model to produce coherent and comprehensive MBO draft objectives covering performance, self-development, and compliance dimensions. Furthermore, the processor is configured to analyze an emotional state of a user and adjust at least one of the numerical objective and the qualitative objective based on the emotional state of the user, so that goal levels and wording can be moderated or intensified according to user motivation, stress, or other emotional indicators. In certain embodiments, the processor is configured to automatically set the numerical objective based on a comparison with a previous period and to adjust the numerical objective according to the emotional state of the user, and is also configured to dynamically adjust the automatically generated MBO draft objective based on a dialogue with the user and the emotional state of the user, thereby achieving a system that continuously and interactively refines MBO objectives in response to both data-driven analysis and human-centered emotional feedback.

The term “system” refers to an arrangement of hardware and/or software components, including at least one processor and associated memory, configured to execute the functions described in the claims.

The term “processor” refers to one or more hardware processing units, such as a central processing unit (CPU), graphics processing unit (GPU), digital signal processor (DSP), or specialized accelerator, that execute instructions to perform the operations recited in the claims.

The term “previous-period objective” refers to a numerical or other quantifiable goal that was set for a user or an organization for a past evaluation period, such as a prior fiscal quarter or year.

The term “current performance data” refers to data representing actual performance results for an ongoing or most recently completed evaluation period, including, for example, sales amounts, quantity of tasks completed, or other measurable indicators.

The term “growth rate” refers to a value that indicates a degree of increase or decrease in performance by comparing the current performance data with the previous-period objective, for example, expressed as a ratio or percentage.

The term “achievement rate” refers to a value that indicates a degree of attainment of the previous-period objective by comparing the current performance data with the previous-period objective, for example, expressed as a ratio or percentage of completion.

The term “user skill set information” refers to data describing capabilities, competencies, knowledge, or expertise possessed by a user, such as technical skills, business skills, or soft skills.

The term “career path information” refers to data indicating a user's current role, desired future role, promotion plan, or progression within an organization, including target positions or job categories.

The term “qualitative objective” refers to a non-numerical goal, typically expressed in natural language, that aims to improve user behavior, skills, knowledge, or other qualitative aspects, including self-development objectives.

The term “self-development” refers to activities and efforts by a user to improve personal skills, competencies, or knowledge, such as training, education, or practice, that contribute to professional growth.

The term “legal information” refers to information relating to laws, regulations, standards, guidelines, or internal compliance rules that are applicable to a business operation or user role.

The term “objective that takes legal compliance into account” refers to an objective that explicitly incorporates requirements derived from legal information so that user behavior or business processes are aligned with applicable laws and regulations.

The term “numerical objective” refers to a goal expressed as a numeric value or range, such as a target sales amount, number of completed tasks, or percentage of improvement.

The term “legal compliance objective” refers to a qualitative or quantitative goal that specifies actions or outcomes intended to ensure adherence to legal or regulatory requirements.

The term “management by objectives (IBO) draft objective” refers to a preliminary set of goals, including numerical, qualitative, and legal compliance objectives, generated by the system as a candidate for a final management by objectives plan.

The term “generative artificial intelligence model” refers to a machine learning model, such as a large language model or other generative model, that is capable of generating text or other content in response to input data or prompts.

The term “prompt text” refers to a structured natural-language or machine-readable text input that is provided to the generative artificial intelligence model to cause the model to generate the management by objectives draft objective.

The term “emotional state” refers to a psychological or affective condition of a user, such as stress, motivation, satisfaction, frustration, or other emotions, which may be inferred from user interactions, biometric data, or other signals.

The term “analyze an emotional state” refers to processing data related to a user's behavior, input, voice, facial expression, physiological signals, or other indicators to estimate or classify the user's emotional state.

The term “dialogue with the user” refers to an interactive exchange of information between the system and the user, conducted via text, voice, graphical user interface, or other communication means, in which the user can provide feedback, preferences, or corrections.

The term “dynamically adjust” refers to modifying at least one parameter or content of an objective in real time or near real time in response to updated information, such as user dialogue or emotional state, without requiring a complete regeneration of the system configuration.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

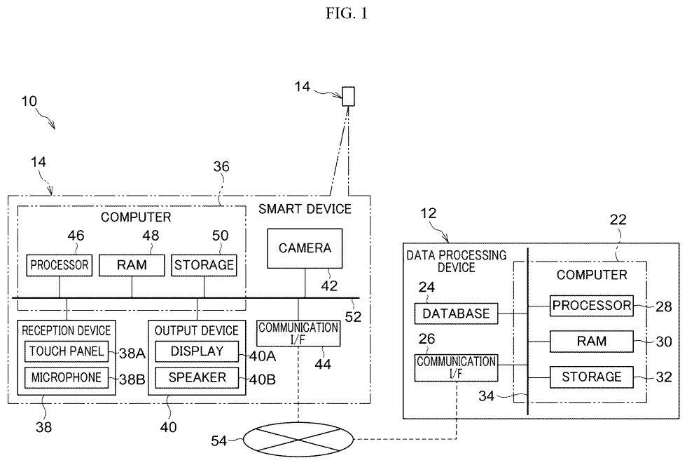

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

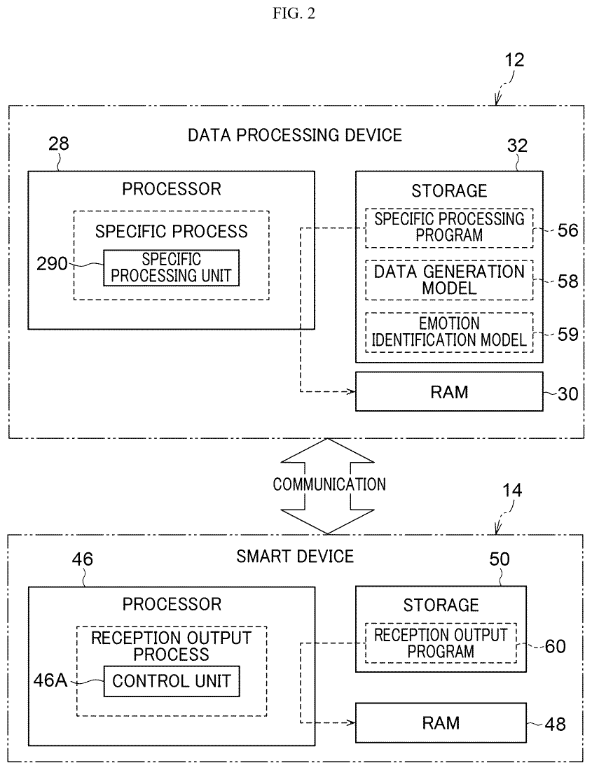

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional goal management systems for management-by-objectives (MBO) generally treat numerical targets, qualitative self-development targets, and legal-compliance targets as separate and manually maintained data elements. In such systems, previous-term target information and current performance information are often stored in heterogeneous formats across multiple data repositories, requiring human operators to manually extract, normalize, and compare data in order to calculate growth rates and achievement rates. This manual integration introduces latency, inconsistency, and human error into the goal-setting process and prevents real-time or near real-time adaptation of targets based on updated performance information.

Furthermore, conventional systems typically accept free-text input describing a user's skill set, career path, and evaluation results, but they lack robust natural language processing pipelines that can automatically transform such unstructured natural language information into structured qualitative targets. As a result, qualitative self-development targets are frequently incomplete, inconsistent, or overly generic, and they cannot be reliably used as machine-processable inputs for downstream analytics or automated proposal generation. In addition, legal and regulatory requirements applicable to work activities, such as labor statutes, safety regulations, or industry rules, are often maintained in external statute information systems and provided as complex machine-readable information. Conventional goal management systems do not automatically query such external statute information sources via standardized communication protocols and do not algorithmically extract compliance items to form structured compliance targets. Instead, legal-compliance goals are drafted manually by administrators or legal staff, which leads to outdated or non-uniform compliance coverage, and limits scalability across organizations, jurisdictions, and roles. Moreover, many existing systems do not exploit generative AI models in a structured way. In particular, they do not generate carefully composed prompt sentences that integrate numerical, qualitative, and compliance targets as unified context, and thus cannot systematically drive generative AI models to produce coherent, consistent MBO target proposals. Where generative models are used at all, prompts are often ad-hoc and manually created, which fails to leverage the full benefit of automated data integration and structured context construction.

Additionally, conventional systems rarely account for a user's emotional state when generating or adjusting targets. Even when sensor data, behavior logs, or interaction logs are available, they are not systematically processed to estimate emotional state, nor is such an estimate used to algorithmically adjust target values or deadlines. This deficiency can result in targets that are misaligned with the user's current capacity, motivation, or stress level, and may impair user engagement and performance over time.

Consequently, there is a need for an improved computer-implemented system and server-side processing architecture that: (i) automatically acquires and normalizes previous-term target information and current performance information as structured tabular data; (ii) calculates numerical indicators such as growth rate and achievement rate and automatically sets numerical targets; (iii) performs natural language processing on user-provided free text to derive structured qualitative self-development targets; (iv) queries external statute information sources to automatically set structured compliance targets; (v) integrates these targets into unified integrated target information; (vi) constructs prompt sentences that encode this integrated target information as input to a generative AI model; (vii) uses the resulting generative output as MBO target proposals; and (viii) estimates a user's emotional state from behavior information, input operation information, or biometric-related information to dynamically adjust targets and iteratively regenerate integrated target information and prompt sentences. Such a system improves the functioning of the computer itself by introducing a concrete data processing pipeline that reduces manual intervention, standardizes data representations, optimizes prompts for generative AI models, and enables adaptive goal management responsive to real-time emotional and performance signals.

The specific processing by the specific processing unit 290 of the data processing device 12 in Example 1 is realized by the following means.

The present invention provides a server comprising a processor and an information storage device, the processor being configured to acquire previous-term target information and current performance information as structured information from the information storage device, to extract the structured information by using an information retrieval language, to hold the extracted information as tabular information by using an information analysis library, to execute arithmetic operations on the tabular information to calculate numerical indicators including a growth rate and an achievement rate, and to automatically set a numerical target based on the numerical indicators; to acquire, as natural language information, skill set information, career path information, and evaluation information of a user that are input from a terminal device, to segment and annotate the natural language information by using a natural language processing library, to extract phrases relating to skills and phrases relating to career orientation, and to set, as structured information, a qualitative target for self-development based on the extracted phrases; to transmit a request signal to an external statute information providing apparatus by using a communication protocol, to acquire statute information related to work as machine-readable information, to extract compliance items from the statute information, and to set, as structured information, a compliance target based on the extracted compliance items; to generate integrated target information by integrating the numerical target, the qualitative target, and the compliance target, to summarize and classify the integrated target information, and to generate a target generation instruction text that constitutes a prompt sentence to be used as input to a generative AI model; to input the prompt sentence to the generative AI model, to acquire natural language text including an MBO target proposal corresponding to the integrated target information, and to hold the natural language text as proposal information; to estimate an emotional state of the user based on behavior information, input operation information, or biometric-related information acquired from the user, and to adjust at least one of a target value and a deadline of the numerical target and the qualitative target in accordance with the emotional state; and to output the proposal information and adjusted target information to the terminal device, and to regenerate the integrated target information and the prompt sentence based on feedback information obtained through interaction with the user. This enables a computer-based goal management system to automatically integrate heterogeneous performance, capability, and legal data into unified structured targets, to construct optimized prompt sentences for a generative AI model that produces coherent MBO target proposals, and to dynamically adapt numerical, qualitative, and compliance targets in response to the user's emotional state and interactive feedback, thereby improving the efficiency, accuracy, personalization, and technical performance of computer-implemented goal setting and adjustment.

The term “previous-term target information” refers to information indicating one or more target values or objectives defined for a past evaluation period, stored as structured data associated with a user, an organization, or an activity.

The term “current performance information” refers to information indicating one or more measured results, outcomes, or performance values for a present or latest evaluation period, stored as structured data corresponding to previously set targets.

The term “structured information” refers to information stored or processed in a predefined format, such as a table, record, or field-based schema, that allows programmatic querying, joining, and arithmetic operations.

The term “information storage device” refers to any hardware component or subsystem capable of storing digital information, such as a memory device, a magnetic or optical storage device, or a solid-state storage device.

The term “information retrieval language” refers to a formal language used to query and manipulate structured information stored in an information storage device, such as a query language for tabular or relational data.

The term “information analysis library” refers to a software component or collection of software routines configured to process structured information, including loading, transforming, aggregating, and performing arithmetic operations on tabular data.

The term “tabular information” refers to structured information represented in a table-like format composed of rows and columns, where each column corresponds to an attribute and each row corresponds to a record or instance.

The term “numerical indicator” refers to a value expressed as a number that quantitatively represents a characteristic of performance or progress, such as a rate, ratio, or index.

The term “growth rate” refers to a numerical indicator representing a relative change in performance between a previous period and a current period, typically computed as a percentage based on the difference between current performance and previous targets or previous performance.

The term “achievement rate” refers to a numerical indicator representing the proportion of a target that has been fulfilled, typically computed as a ratio or percentage of actual performance relative to a corresponding target value.

The term “numerical target” refers to a goal expressed as one or more numerical values, such as a quantity, amount, or rate, to be achieved by a specified time.

The term “natural language information” refers to information expressed in a human language, such as sentences or phrases input by a user, that is not constrained to a predefined structured format.

The term “natural language processing library” refers to a software component or collection of software routines that analyze natural language information, including tokenization, segmentation, annotation, and extraction of linguistic or semantic features.

The term “skill set information” refers to natural language or structured information describing abilities, competencies, or technical and non-technical skills possessed by a user.

The term “career path information” refers to natural language or structured information describing desired or planned future roles, responsibilities, or positions that a user aims to pursue over a period of time.

The term “evaluation information” refers to natural language or structured information indicating assessments, feedback, ratings, or review results related to a user's performance or behavior.

The term “phrase relating to skills” refers to a sequence of words extracted from natural language information that denotes a capability, competency, or area of expertise of a user.

The term “phrase relating to career orientation” refers to a sequence of words extracted from natural language information that denotes a desired role, position, responsibility, or direction of professional development for a user.

The term “qualitative target” refers to a goal describing an intended improvement or outcome that is expressed in descriptive terms rather than solely as a numerical value, such as development of leadership or communication abilities.

The term “qualitative target for self-development” refers to a qualitative target specifically directed to a user's personal or professional growth, such as enhancing specific skills, behaviors, or competencies.

The term “external statute information providing apparatus” refers to an external system, device, or service that supplies digital information representing laws, regulations, or rules applicable to work or organizational activities.

The term “communication protocol” refers to a predefined set of rules and formats used to transmit and receive information between the server and an external apparatus over a network.

The term “statute information” refers to information representing provisions of laws, regulations, or rules, including articles, clauses, and associated requirements relevant to organizational or individual activities.

The term “machine-readable information” refers to information encoded in a digital format that can be directly read and processed by a computing device without manual transcription.

The term “compliance item” refers to an element of statute information that specifies an obligation, prohibition, condition, or requirement that must be satisfied to comply with a law or regulation.

The term “compliance target” refers to a goal defining actions, states, or outcomes intended to ensure adherence to one or more compliance items, such as completing mandatory training or following time restrictions.

The term “integrated target information” refers to structured information generated by combining numerical targets, qualitative targets, and compliance targets into a unified representation suitable for further processing.

The term “target generation instruction text” refers to a text segment derived from integrated target information that describes how goals should be generated or refined, and that forms part of a prompt sentence to be input to a generative model.

The term “prompt sentence” refers to a text or collection of text segments that encodes instructions, context, or constraints for a generative model, and that is used as input to cause the generative model to produce a desired output.

The term “generative information generation model” refers to a machine learning model, such as a generative AI model, configured to receive a prompt sentence and automatically generate natural language text or other data based on learned patterns.

The term “MBO target proposal” refers to a set of goal descriptions generated to support management-by-objectives, including at least one of numerical targets, qualitative targets, and compliance targets organized as a proposal.

The term “proposal information” refers to data representing an MBO target proposal generated by a generative model, stored as natural language text and optionally associated metadata.

The term “behavior information” refers to data derived from a user's observable actions or interactions with a computing system, such as click patterns, navigation behavior, or usage frequency.

The term “input operation information” refers to data representing the manner in which a user interacts with input devices, such as keypress timing, pointer movements, or touch interactions.

The term “biometric-related information” refers to physiological or behavioral measurements associated with a user, such as heart rate, facial expression indicators, voice characteristics, or other sensor-based signals, that can be used to infer an emotional state.

The term “emotional state” refers to a condition representing a user's affective state, such as stress, engagement, motivation, or fatigue, inferred from one or more sources including behavior information, input operation information, or biometric-related information.

The term “target value” refers to a specific quantitative or qualitative specification within a target, indicating a desired level, outcome, or condition to be achieved.

The term “deadline” refers to a time or time period by which a particular target value or goal is intended to be achieved.

The term “terminal device” refers to an information processing device used by a user to input data and display results, such as a personal computer, a mobile communication device, or another user-facing computing device.

The term “feedback information” refers to information provided by a user in response to displayed proposals or targets, including confirmations, modifications, comments, or additional instructions used to refine or update goals.

The term “integrated target information and the prompt sentence to be regenerated” refers to a process in which previously stored integrated target information and a previously generated prompt sentence are updated or reconstructed based on new data, including feedback information and emotional state estimates, to obtain revised versions for further processing.

In one embodiment, a server cooperates with at least one terminal operated by a user to implement the claimed system. The server includes at least one processor, a main memory, a non-volatile storage device, a network interface, and an information storage device implemented, for example, by a relational database system. The terminal includes at least one processor, a memory, a display device, and one or more input devices such as a keyboard, a pointing device, or a touch panel. The server and the terminal communicate via a digital communication network using standard network protocols.

The server executes an operating system such as a general-purpose server operating system and executes application software implemented in a high-level programming language. The server uses a relational database management system to store previous-term target information, current performance information, user-related information, and generated proposal information as structured records. The server uses a data analysis library such as a tabular data processing library to process tabular information representing relational records.

The server uses a natural language processing library to process free-text information. The server also communicates with an external statute information providing apparatus via a communication protocol such as a REST-based HTTP protocol to obtain statute information in a machine-readable format. The server further communicates with a generative AI model via an API to generate MBO target proposals based on constructed prompt sentences.

The server stores previous-term target information and current performance information in the information storage device in a structured schema. For example, the server stores, for each user and each metric, fields including an identifier, a period, a target value, a performance value, and additional attributes such as a unit and a category. The server uses a query language such as a structured query language to retrieve the previous-term target information and current performance information from the information storage device. The server converts the retrieved records into an internal tabular representation, such as an in-memory table, and associates columns corresponding to previous-period targets and current-period performance values for each metric.

The server uses the data analysis library to perform column-wise and row-wise arithmetic operations on the tabular representation. The server calculates a growth rate as a relative difference between current performance and previous-period target values and calculates an achievement rate as a ratio of current performance to previous-period target values. The server stores the growth rate and achievement rate as additional columns of the tabular representation. The server then derives numerical targets for a next period by applying a predetermined or dynamically computed factor to the current performance values or by applying a rule-based logic that takes into account the growth rate and achievement rate. For example, the server may increase or decrease the numerical target depending on whether the achievement rate exceeds a predetermined threshold. This tabular arithmetic processing reduces rounding errors and ensures consistent application of update rules across multiple metrics, thereby improving the accuracy and repeatability of numerical target computations compared with manual or ad-hoc calculations.

The terminal displays a graphical user interface implemented as a web-based interface or a native application interface. The terminal presents input fields for the user to enter natural language descriptions of a skill set, a desired career path, and evaluation information. The user inputs free-text sentences such as descriptions of current abilities, desired roles, and feedback from supervisors. The terminal transmits the user's natural language information to the server over the network using a secure communication protocol.

The server receives the natural language information and applies a natural language processing pipeline. The server segments the text into tokens and applies part-of-speech tagging and phrase chunking using the natural language processing library. The server identifies noun phrases and verb phrases that correspond to skills, competencies, and career directions by applying domain-specific rule sets and pattern-matching. For example, the server treats noun phrases containing terms such as “management,” “analysis,” or “communication” as candidate skill expressions, and treats embedded expressions such as “want to become” or “plan to be” as indicators of career orientation. The server maps extracted phrases to a normalized skill ontology stored in the information storage device, thereby converting free-text references to standardized skill categories. The server then represents qualitative self-development targets as structured records including fields such as a skill category identifier, an action description, a desired improvement level, and a time frame.

This structured representation allows the qualitative targets to be used as machine-processable inputs in subsequent integration and prompt construction steps and improves consistency and reusability of qualitative target data across different users and evaluation cycles.

The server sends a request to the external statute information providing apparatus using a communication protocol such as HTTPS. The server includes parameters such as a jurisdiction code, an industry category, or a job category to filter relevant statute information.

The external apparatus responds with machine-readable statute information, for example in a structured text-based format, containing data objects that describe laws, articles, and compliance requirements. The server parses the received statute information and applies a rule-based extraction process that identifies compliance items. For example, the server extracts phrases that indicate obligations to limit working hours, to provide safety training, or to maintain records. The server normalizes these obligations into compliance items represented as structured records with fields including a statute identifier, an obligation type, a condition, and a required action. The server generates compliance targets by mapping compliance items to specific actions and deadlines for the user or an associated organization. By automating the extraction and normalization of compliance items, the server reduces dependence on manual legal interpretation and provides consistent coverage of legal requirements across users and time periods.

The server integrates the numerical targets, qualitative targets, and compliance targets into integrated target information. The server associates each target record with identifiers for a user, a metric or skill, a statute, and a period. The server aggregates and classifies records into groups such as numerical goal group, qualitative self-development goal group, and compliance goal group. The server generates human-readable summaries of each group by applying template-based text generation on the structured fields of the records, such as converting a numerical target record into a sentence describing the previous term's target, current performance, calculated growth rate, achievement rate, and proposed new target. The server constructs a prompt sentence from the integrated target information. The server combines the human-readable summaries into a coherent text that includes explicit sections for numerical information, qualitative information, and compliance information, and appends task instructions and output formatting requirements. One example of a prompt sentence used in the generative AI model is:

“Previous term's sales target was 10,000,000 JPY, and current term's sales result is 12,000,000 JPY. This corresponds to a 20.0% growth and 120.0% achievement. A reasonable reference for the next sales target is 13,200,000 JPY.

The user's current skill set includes project management and basic data analysis. The user wants to become a project leader and later a department manager, and therefore wishes to strengthen leadership and people management capabilities.

Relevant laws include the Labor Standards Act, which requires limiting working hours to statutory maximums and providing regular safety and health training. The organization must fully comply with these obligations.

Using this information, create an integrated MBO goal proposal. Include:
At least three numerical goals with concrete values and time frames.
At least three qualitative self-development goals.
At least two legal-compliance goals related to working hours and safety training.

Write the goals in clear business English, in bullet-point format, and group them under the headings ‘Numerical Goals’, ‘Qualitative Development Goals’, and ‘Compliance Goals’.” The server inputs the constructed prompt sentence to a generative AI model using an interface such as a network-based API. In one embodiment, the generative AI model is implemented as a neural network of the transformer type, including an input embedding layer, a plurality of self-attention layers, and a feed-forward output layer trained on large corpora of text to predict next tokens conditioned on preceding tokens. The server encodes the prompt sentence into a token sequence using a tokenizer consistent with the generative model's vocabulary. The generative model processes the token sequence by performing multi-head attention computations at each layer, computing attention weights over prior tokens, and propagating activations through non-linear transformations. The generative model produces output token probabilities at each step, and the server selects tokens according to a decoding strategy, such as greedy decoding or sampling with a temperature parameter, to generate a natural language text sequence representing an MBO target proposal. The server receives the generated text sequence from the generative AI model and treats it as proposal information. The server may further parse the generated text to identify sections corresponding to numerical goals, qualitative development goals, and compliance goals by detecting headings or bullet structures. The server stores the proposal information and associated metadata, such as the prompt sentence and timestamps, in the information storage device. By using a transformer-based generative AI model with an integrated prompt that encodes structured target data, the server enables multi-dimensional target proposal generation that considers historical performance, qualitative development needs, and legal requirements simultaneously. This approach is different from simple template filling or rule-based generation and leverages the neural network's learned representations to generate nuanced and coherent proposals that would be difficult to obtain by manual rule design. The terminal retrieves the generated proposal information from the server and displays it on the user's screen. The terminal presents the goals grouped by category and allows the user to review and modify the generated descriptions. The user may adjust target values, rephrase qualitative objectives, or add comments via the terminal interface. The terminal sends the user's feedback information to the server. The server updates the integrated target information and may reconstruct an updated prompt sentence that reflects the changes, enabling iterative refinement of the MBO target proposal through further interaction with the generative AI model.

The server further acquires behavior information, input operation information, and biometric-related information from the terminal or from connected sensors. For example, the terminal can measure keypress dynamics, pointer movement patterns, and response times, and external sensors may provide physiological signals such as heart rate or facial expression indicators. The server processes this data to estimate the user's emotional state. In one embodiment, the server uses a separate machine learning model defined as a neural network that takes as input feature vectors derived from the behavior and biometric data, such as statistical features of keypress intervals, cursor movement entropy, and heart rate variability. The server trains this model in advance using supervised learning with labeled emotional states, applying a loss function such as cross-entropy loss and an optimization algorithm such as gradient-based stochastic optimization to update the network's weights. During inference, the server computes a probability distribution over emotional state categories and selects a category such as “high stress” or “high engagement.”

The server uses the estimated emotional state to adjust at least one of a target value and a deadline of the numerical and qualitative targets. For example, when the emotional state indicates that the user is under high stress, the server may reduce the growth factor used to compute the next numerical target or extend a deadline for achieving a qualitative development goal. Conversely, when the emotional state indicates high engagement and a strong achievement trend, the server may modestly increase the numerical target or add an additional qualitative challenge. These adjustments are applied through algorithmic rules defined in the server software and recorded as updates to the structured targets in the information storage device. By systematically incorporating emotional state estimates into target adjustment, the server provides an adaptive mechanism that is not a mere automation of human decision-making, but rather a data-driven optimization that uses sensor-derived features and predictive models in a consistent and repeatable manner.

The described architecture improves computer technology in several ways. First, the server's use of a unified tabular data structure and a data analysis library for numerical target computation reduces redundant queries and manual recalculations, which enhances processing speed and reduces computational error. Second, the mapping of unstructured natural language information to structured qualitative targets via ontology-based normalization enables efficient indexing, retrieval, and reuse of qualitative data, improving data management and computational efficiency. Third, the automated retrieval and normalization of statute information through a communication protocol and structured compliance item extraction reduces network traffic by requesting only relevant categories and by caching normalized compliance items, thereby reducing communication load. Fourth, the construction of optimized prompt sentences that encode integrated target information provides an interface layer between structured data processing and the generative AI model, enabling the generative model to produce higher-quality output with fewer iterations, which reduces API calls and latency. Fifth, the use of a dedicated emotional-state estimation network, trained with explicit feature engineering and loss-based optimization, provides a technical means to incorporate user state into target adjustment that is systematically more accurate and faster than ad-hoc human interpretation of behavior signals.

The server thus performs a specific sequence of data transformations: from stored relational records to tabular representations; from tabular metrics to numerical indicators and updated targets; from natural language skill and career descriptions to normalized qualitative targets; from statute documents to structured compliance targets; and from integrated targets to prompt sentences and generated proposals. Each transformation is implemented using specific algorithms, data structures, and machine learning models. Because these transformations are executed by the server according to predetermined rules and trained model parameters, the system achieves improvements in calculation accuracy, adaptability, and throughput compared with systems that rely solely on manual editing or simplistic automation. The system also allows alternative embodiments in which parts of the processing are distributed between the server and the terminal, in which different model architectures are used for the generative AI model or the emotional-state model, and in which different storage formats or communication protocols are selected, while still operating within the scope of the claimed invention.

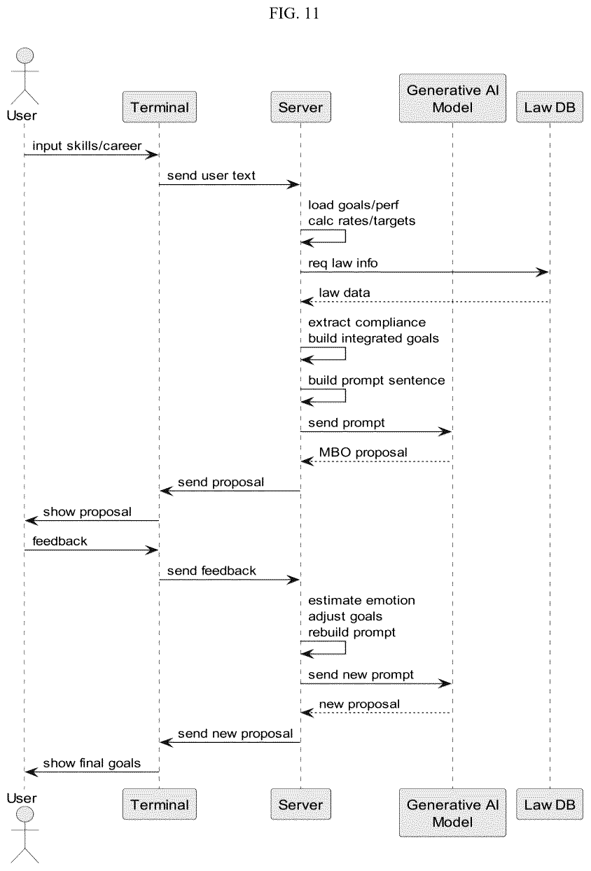

The following describes the processing flow using FIG. 11.

### Step 1:

Server acquires previous-term target information and current performance information from an information storage device.

Server uses a query language to retrieve, as input, records including user identifiers, metric identifiers, periods, target values, and performance values.

Server converts the retrieved records into tabular information by mapping each record to a row and each attribute to a column.

Server outputs a pair of tabular datasets corresponding to previous-term targets and current-term performance for each metric.

### Step 2:

Server integrates the previous-term target information and current performance information into a unified tabular structure.

Server uses the metric identifier and user identifier as input keys to join the two tabular datasets.

Server executes a join operation and aligns columns such that each row contains a previous-term target value and a current-term performance value for the same metric and user.

Server outputs a merged table in which each row is ready for numerical computation of growth and achievement.

### Step 3:

Server calculates numerical indicators including a growth rate and an achievement rate and sets numerical targets.

Server takes as input the merged table containing previous-term target values and current performance values.

Server performs arithmetic operations on each row, computing the growth rate as a relative change between the current performance value and the previous-term target value, and computing the achievement rate as a ratio of the current performance value to the previous-term target value.

Server further applies predetermined rules or factors to these indicators to derive a new numerical target value for each metric.

Server outputs an enriched table that includes, for each metric, the growth rate, the achievement rate, and a proposed new numerical target.

### Step 4:

Terminal presents a graphical user interface and collects natural language information about a user's skill set, career path, and evaluation.

Terminal receives, as input, free-text entries that the user types into text fields describing abilities, desired roles, and feedback from evaluations.

Terminal packages the text into a structured message and transmits the message to the server over a communication network.

Terminal outputs the user's free-text information as a network request addressed to the server.

### Step 5:

Server processes the user's natural language information to extract skill-related phrases and career-orientation phrases and to set qualitative targets.

Server receives, as input, the free-text skill set information, career path information, and evaluation information from the terminal.

Server applies a natural language processing library to tokenize the text, assign part-of-speech tags, and identify candidate phrases.

Server executes rule-based pattern matching to detect phrases that correspond to skills and desired career directions and maps these phrases to entries in an internal skill ontology.

Server constructs qualitative target records that describe self-development goals, each record including a normalized skill category, an action description, and a desired time frame.

Server outputs a set of structured qualitative targets associated with the user.

### Step 6:

Server retrieves statute information from an external statute information providing apparatus and generates compliance targets.

Server sends, as input, a request containing parameters such as jurisdiction and job category to the external apparatus via a communication protocol.

Server receives machine-readable statute information describing laws, articles, and associated requirements.

Server parses the statute information and performs pattern-based extraction to identify compliance items that express obligations, prohibitions, or conditions relevant to work activities.

Server converts the extracted compliance items into structured compliance target records that specify required actions, conditions, and deadlines.

Server outputs a set of structured compliance targets linked to the user or to an associated organizational unit.

### Step 7:

Server integrates numerical targets, qualitative targets, and compliance targets into integrated target information.

Server takes as input the enriched numerical target table, the structured qualitative targets, and the structured compliance targets.

Server normalizes identifiers and merges these data into a unified representation by associating each target with a user identifier, a category (numerical, qualitative, or compliance), and a time frame.

Server groups targets into logical clusters, such as performance metrics, development goals, and legal obligations.

Server outputs integrated target information that provides a consolidated view of all targets for the user.

### Step 8:

Server constructs a prompt sentence for a generative AI model based on the integrated target information.

Server receives, as input, the integrated target information including numerical indicators, qualitative descriptions, and compliance requirements.

Server generates human-readable summary sentences for each group by applying text templates and inserting values such as previous-term targets, current performance, growth rate, achievement rate, existing skills, desired roles, and key legal obligations.

Server concatenates these summaries and appends explicit task instructions and output formatting requirements, thereby forming a coherent prompt sentence.

Server outputs the constructed prompt sentence as text ready to be transmitted to the generative AI model.

### Step 9:

Server sends the prompt sentence to a generative AI model and acquires an MBO target proposal.

Server takes the prompt sentence as input and transmits it to the generative AI model through an application programming interface.

Server causes the generative AI model, implemented as a neural network, to process the tokenized prompt and generate a sequence of output tokens forming natural language text.

Server receives the generated text containing proposed numerical goals, qualitative development goals, and compliance goals, and associates this text with the originating prompt sentence and user.

Server outputs proposal information representing an MBO target proposal in natural language.

### Step 10:

Server stores the proposal information and associated metadata in the information storage device.

Server takes as input the generated proposal text, the prompt sentence, and identifiers for the user and the processing session.

Server creates records that include the text of the proposal, the time of generation, and references to the integrated target information used to create the prompt.

Server writes these records to persistent storage to support future retrieval, comparison, and auditing.

Server outputs confirmation that the proposal information has been successfully stored.

### Step 11:

Terminal obtains the proposal information from the server and displays it to the user.

Terminal receives, as input, the proposal text and related metadata from the server through a network response.

Terminal parses the response and organizes the content into sections such as numerical goals, qualitative development goals, and compliance goals for presentation.

Terminal renders the text on the display device and provides editable fields or controls for the user to review and modify individual goals.

Terminal outputs a user interface that visualizes the generated MBO target proposal.

### Step 12:

User reviews and optionally modifies the generated proposal using the terminal interface.

User takes the displayed goals as input and reads descriptions and target values presented on the terminal.

User edits text fields, adjusts numerical target values, or adds comments and additional constraints as desired.

User confirms or submits the modifications through an interaction control such as a button or menu command.

User outputs feedback information in the form of updated goal descriptions and comments.

### Step 13:

Terminal transmits user feedback information to the server for updating targets.

Terminal receives, as input, the user's edited goal text, changed target values, and comments from the user interface.

Terminal encodes this feedback information into a structured message including identifiers for each goal and the corresponding modifications.

Terminal sends the message to the server over the communication network.

Terminal outputs a network request that carries feedback information for server-side processing.

### Step 14:

Server acquires behavior information, input operation information, and biometric-related information and estimates the user's emotional state.

Server receives, as input, logs from the terminal and sensors that indicate typing speed, pointer movement patterns, response times, and physiological measures such as heart rate or facial expression indicators.

Server transforms these raw signals into feature vectors by computing statistical measures including means, variances, and temporal patterns.

Server applies a trained emotional-state estimation model to the feature vectors and produces probabilities for predefined emotional categories such as high stress or high engagement.

Server selects the most likely emotional state and outputs an emotional state estimate associated with the user and the current session.

### Step 15:

Server adjusts numerical targets and qualitative targets based on the estimated emotional state and user feedback.

Server takes as input the emotional state estimate, the integrated target information, and the user feedback information.

Server applies adjustment rules that modify target values or deadlines in accordance with the emotional state, for example reducing growth requirements under high stress or increasing development expectations under high engagement.

Server also incorporates explicit user feedback by updating descriptions and parameters of individual goals within the integrated target information.

Server outputs updated integrated target information that reflects both emotional state-based adjustments and user-driven changes.

### Step 16:

Server regenerates the prompt sentence and optionally regenerates the MBO target proposal using the updated integrated target information.

Server takes as input the updated integrated target information that now includes adjusted numerical and qualitative targets and any refined compliance targets.

Server reconstructs a new prompt sentence by summarizing the updated targets and reapplying task instructions and formatting constraints in text form.

Server optionally sends the updated prompt sentence to the generative AI model to obtain a revised MBO target proposal, and receives updated proposal text.

Server outputs the regenerated prompt sentence and any regenerated proposal information for subsequent storage and display.

### Step 17:

Server and terminal repeat display and adjustment based on regenerated information to converge on finalized targets.

Server provides, as input to the terminal, the regenerated proposal text and the underlying adjusted target information.

Terminal updates the user interface with the new proposal and highlights changes relative to the prior version.

User examines the revisions, and the cycle of review, feedback, emotional state estimation, target adjustment, and proposal regeneration may be repeated until the user accepts the final set of goals.

Server and terminal output a finalized set of numerical targets, qualitative development targets, and compliance targets aligned with performance history, legal requirements, and the user's emotional state.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computerized goal management systems for operation of industrial equipment are typically limited to static target setting workflows in which numerical targets are manually entered based on human judgment, qualitative targets are loosely defined without systematic linkage to operation data, and compliance-related targets are handled in separate systems. As a result, such systems suffer from several technical limitations in terms of computer technology itself.

First, conventional systems do not perform integrated machine-based processing that jointly uses past operation information, user attribute information, and regulation information to automatically compute and structure goal information. Instead, a large portion of the processing is carried out mentally by human operators. This leads to fragmented data flows, duplicated input operations, and inefficient utilization of storage and processing resources. The processor is underutilized or only executes simple retrieval functions, while the burden of analysis and integration remains on the user side.

Second, even when some numerical calculations are implemented, conventional systems generally compute numerical targets using fixed formulas and do not adaptively adjust those targets based on dynamically acquired state information of the user, such as workload, stress level, or engagement. The system therefore fails to optimize internal processing paths for updating target information in response to changing conditions. This results in rigid data structures for target information and requires repeated manual editing of goals, increasing network traffic and write operations to storage devices.

Third, existing systems do not provide a unified, machine-executable mechanism for transforming heterogeneous data—such as past operation logs, user profiles, and regulation texts—into a structured prompt sentence suitable for input to a generative AI model. In many cases, prompts are manually composed outside the system, and the system merely stores the AI output as unstructured text. This prevents the computer from systematically controlling how prompt content is constructed, limits reproducibility of AI outputs, and hinders effective caching, batching, and optimization of communication with external information processing services.

Fourth, conventional systems do not tightly integrate AI-generated target-candidate information with subsequent interactive adjustments performed via terminal devices. Adjustments performed by users on terminal interfaces are often recorded as unlinked free text or disconnected configuration values, without maintaining a structured relationship between original AI-generated candidates, user modifications, and the underlying operation and attribute data. As a consequence, the processor cannot reliably trace the provenance of each updated target, cannot effectively reuse past AI interactions, and cannot optimize later cycles of goal generation.

Fifth, there is no standardized, computer-implemented workflow for iteratively updating target-management information using both interaction-operation information from terminal devices and user state information, while maintaining data consistency and minimizing unnecessary recomputation. Existing architectures typically require the user to re-trigger entire goal-generation processes, resulting in redundant queries to storage, repeated AI calls, and inconsistent intermediate states in memory and databases.

Accordingly, there is a need for a computer-implemented system that improves the internal functioning of processors and storage devices by: (i) automatically aggregating and computing operation metrics; (ii) automatically forming prompt sentences for a generative AI model from integrated operation, user, and regulation data; (iii) automatically generating and updating structured target-management information including AI-generated candidates; and (iv) adjusting that information based on user state and terminal-side interaction, thereby improving computational efficiency, data consistency, and utilization of external AI services.

The specific processing by the specific processing unit 290 of the data processing device 12 in Application Example 1 is realized by the following means.

The present invention provides a server comprising a processor and one or more storage devices, the processor being configured to obtain, from the storage devices, past operation information of industrial equipment, compare previous-period target information with current performance information, calculate growth-rate information and achievement-rate information, and automatically set numerical target information for a next period of the industrial equipment based on the growth-rate information and the achievement-rate information; obtain, from the storage devices, user attribute information including skill information, career information, and evaluation information, and set qualitative target information for self-improvement based on the user attribute information; obtain, from the storage devices, regulation information including law information and rule information related to an operation of the industrial equipment, and set compliance target information based on the regulation information; integrate the numerical target information, the qualitative target information, and the compliance target information to generate integrated target information; generate, based on the integrated target information, the operation information, and the user attribute information, prompt-sentence information formatted for input to a generative AI model; transmit the prompt-sentence information to an external information processing service, receive target-candidate information output by the generative AI model from the external information processing service, and automatically generate structured target-management information including the target-candidate information; transmit the target-management information to a terminal device and update the target-management information based on modification information received from the terminal device; and obtain state information of a user and adjust at least one of the numerical target information and the qualitative target information based on the state information. This enables the computer system itself to execute an improved, integrated goal-generation and management workflow in which heterogeneous data sources are machine-processed into optimized prompt sentences, generative AI output is automatically incorporated into structured target-management information, and targets are adaptively adjusted based on user state and terminal-side interactions, thereby enhancing computational efficiency, data consistency, and effective utilization of external AI services compared to conventional systems.

The term “system” refers to a combination of hardware and software components including at least one processor and at least one storage device configured to execute the claimed processing operations.

The term “processor” refers to one or more hardware processing units, such as a central processing unit or other computation circuitry, capable of executing machine-readable instructions to perform the claimed functions.

The term “storage device” refers to one or more non-transitory computer-readable media, such as magnetic storage, optical storage, or semiconductor memory, configured to store data and programs used by the processor.

The term “operation information” refers to data representing past or current operation states of industrial equipment, including, for example, production quantities, operating times, downtime events, and maintenance events.

The term “industrial equipment” refers to machinery, apparatus, or production devices used in manufacturing or processing environments to produce or process goods or materials.

The term “previous-period target information” refers to data indicating goals or target values that were set for a prior time period, such as a previous month, quarter, or year, for the operation of the industrial equipment.

The term “current performance information” refers to data indicating actual operation results of the industrial equipment for a current time period, including measured values corresponding to prior target values.

The term “growth-rate information” refers to data representing a rate of change, such as an increase or decrease, between performance measures of different time periods, typically expressed as a ratio or percentage.

The term “achievement-rate information” refers to data representing a degree to which actual performance meets or deviates from corresponding target values, typically expressed as a ratio or percentage of achievement.

The term “numerical target information” refers to goal data expressed as numerical values, such as target production quantities, target maintenance frequencies, or target downtime durations for future operation periods.

The term “next period” refers to a future time interval, such as a subsequent month, quarter, or year, for which new target information is to be set.

The term “user attribute information” refers to data describing characteristics of a user, including skill information, career information, evaluation information, and other profile-related information.

The term “skill information” refers to data indicating technical abilities, qualifications, certifications, or competencies of a user relevant to operating or managing industrial equipment.

The term “career information” refers to data describing a user's professional history and desired future career direction, including roles, positions, responsibilities, and career objectives.

The term “evaluation information” refers to data indicating results of assessments or performance reviews of a user, including ratings, feedback, and achievement records.

The term “qualitative target information” refers to non-numerical goal data describing desired improvements or behaviors, such as self-improvement objectives, skill development goals, or work-style enhancements.

The term “self-improvement” refers to enhancement of a user's skills, knowledge, or work practices, as expressed in qualitative target information.

The term “regulation information” refers to data representing externally imposed or internally defined rules applicable to the operation of industrial equipment, including law information and rule information.

The term “law information” refers to data representing statutory requirements, regulations, or official directives issued by governmental or regulatory bodies.

The term “rule information” refers to data representing internal policies, standards, guidelines, or procedures defined within an organization.

The term “compliance target information” refers to goal data specifying actions or conditions required to satisfy applicable regulation information, including legal and internal rule requirements.

The term “integrated target information” refers to data obtained by combining numerical target information, qualitative target information, and compliance target information into a unified structure suitable for further processing.

The term “prompt-sentence information” refers to text data formatted as an input sentence or set of sentences designed to be provided to a generative AI model to obtain target-candidate information.

The term “generative AI model” refers to a machine-learning-based model configured to generate text or other content in response to input data, based on patterns learned from training data.

The term “external information processing service” refers to a remote computing service accessible via a communication network, which executes the generative AI model and returns output data in response to prompt-sentence information.

The term “target-candidate information” refers to goal-related data generated by the generative AI model based on prompt-sentence information, including proposed numerical, qualitative, or compliance-related goals.

The term “target-management information” refers to structured data representing a collection of goal-related information, including at least target-candidate information and associated metadata used for managing and tracking goals.

The term “terminal device” refers to a user-operated computing device, such as a mobile device, tablet, or personal computer, configured to communicate with the server, present target-management information, and transmit user input.

The term “modification information” refers to data representing changes or adjustments made by a user to target-management information via a terminal device, including edits to targets, additions, or deletions.

The term “state information” refers to data indicating a condition of a user at a given time, such as workload state, emotional state, stress state, engagement level, or other context affecting suitability of goals.

The term “table-format information processing” refers to processing of data organized in a tabular structure, such as rows and columns, including operations like aggregation, filtering, grouping, and calculation.

The term “arithmetic-processing program execution environment” refers to a software environment or runtime in which arithmetic and logical operations on data are executed by the processor, including environments supporting table-format information processing.

The term “interaction-operation information” refers to data representing user operations performed via a user interface on a terminal device, such as selections, edits, confirmations, or other interaction events.

The term “dynamically update” refers to modifying target-management information in response to new data, such as interaction-operation information or state information, without recreating the information from scratch.

In one embodiment, a server executes a goal-management program on general-purpose computing hardware, and a terminal and a user cooperate with the server to generate and adjust goal information for operation of industrial equipment.

The server includes at least one processor, a main memory, and a non-transitory storage device, such as a magnetic disk or a solid-state drive. The server further includes a communication interface connected to a network. The server runs an operating system such as a server-class operating system and executes application software including a database management system, a numerical computation environment, and a generative AI client module. In one example, the server uses a relational database management system to store operation information, user attribute information, regulation information, and target-management information. The server uses a numerical computation environment that supports table-format information processing, such as a library configured to provide data frame objects, aggregation functions, and statistical operations.

The server stores a goal-management program that is loaded into the main memory and executed by the processor. The goal-management program is modularized into components including an operation-data aggregation module, a user-attribute processing module, a regulation-processing module, a prompt-generation module, a generative-AI interaction module, a target-integration module, and a state-based-adjustment module. Each module is implemented as machine-executable instructions that process specific data structures defined in the program.

The server uses the operation-data aggregation module to process operation information of industrial equipment. The server stores operation logs in the database as records containing fields such as equipment identifier, time stamp, production quantity, downtime duration, and maintenance event flags. The server loads such records into a table-format structure in memory, where each column corresponds to a field and each row corresponds to a time-stamped event. The server applies group-by aggregation functions keyed by period identifiers (for example, a month code or a quarter code) to compute sums, averages, and counts of the production quantities and maintenance events. The server then generates previous-period target information and current performance information by reading target records and actual performance records from the database, and calculates growth-rate information and achievement-rate information by performing arithmetic operations on the aggregated columns. By maintaining these table-format structures in memory and operating on them with vectorized arithmetic operations, the server reduces the number of per-record iterations and significantly improves processing throughput compared to naïve record-by-record processing.

The server uses the user-attribute processing module to construct structured user attribute information. The server stores user profiles in the database in normalized tables including skill tables, career-history tables, and evaluation tables. The server joins these tables using user identifiers and loads the combined data into an in-memory representation that includes arrays of skill tags, chronological career events, and evaluation scores. The server converts this representation into a compact textual summary by applying template-based formatting rules. For example, the server may output a sentence describing the dominant skill categories, the current role, and recent performance trends. This structured textual summary later becomes an element of a prompt sentence.

The server uses the regulation-processing module to process regulation information that includes law information and rule information. The server stores law texts and internal rules as documents in the database, indexed by jurisdiction, industry, and equipment type. The server retrieves documents matching the equipment type and applicable region, and applies rule-based parsing procedures to extract obligation statements, time constraints, and threshold conditions. For instance, the server searches for patterns such as “at least once every [X] months” or “must not exceed [Y] hours of continuous operation.” The server encodes each extracted element as a compliance target candidate structure with attributes such as required action, frequency, and deadline. By converting unstructured regulation text into structured compliance target information, the server enables subsequent algorithmic combination with numerical targets and qualitative targets.

The server uses the prompt-generation module to generate prompt-sentence information for a generative AI model. The server constructs the prompt sentence by embedding numerical target information, qualitative summaries of user attributes, and compliance requirements into a predetermined template. The template defines explicit positions for production quantities, maintenance frequencies, performance trends, skill descriptions, and regulatory constraints. The server applies deterministic formatting rules to ensure that each numeric value and categorical label is placed in a consistent order and with explicit units. This structure enables the generative AI model to receive standardized, machine-generated context information, which facilitates reproducible behavior and allows the server to cache and reuse AI outputs for similar prompt patterns.

An example of such a prompt sentence is:

“The previous period's production output was 1000 parts, and maintenance was performed once per month. The planned target output for the next period is 1100 parts, and the planned maintenance frequency is 1.5 times per month. The operator currently has skills in basic machine operation and troubleshooting and aims to advance toward predictive maintenance and data analysis. Applicable internal rules require that safety inspections be conducted at least once every three months. Based on this situation, propose qualitative self-improvement goals for the operator and refined production and maintenance goals that are challenging but achievable while satisfying the safety inspection requirement.”

The server uses the generative-AI interaction module to communicate with a generative AI model provided by an external information processing service. The generative AI model is, in one embodiment, an encoder-decoder transformer neural network trained to generate text conditioned on input tokens. The server encodes the prompt sentence into tokens according to a predefined tokenizer and sends these tokens, along with inference parameters such as maximum token length, sampling temperature, and top-k or top-p parameters, to the external service via a network API. The generative AI model internally computes contextual embeddings for each token using multiple layers of self-attention and feed-forward networks, and then produces probability distributions over output tokens at each generation step. The external service returns the sequence of output tokens, which the server decodes back into a natural language sequence representing target-candidate information.

The server uses the target-integration module to map the AI-generated target-candidate information into structured target-management information. The server parses the generated text according to pattern-matching rules and domain-specific markers. For example, the server may require that the generative AI model output goals prefixed with labels such as “Numerical goal:” or “Qualitative goal:”. The server splits the AI output on these labels and stores each goal as a record with fields including goal type, description, suggested value, and priority score. When a numerical value is present in the generated text, the server converts it into a numeric type and checks its consistency against the previously computed growth-rate information and achievement-rate information. If a conflict exceeds a threshold, the server applies conflict-resolution rules that either adjust the suggested value to a permissible range or flag the goal for manual review. This structured integration enables the server to combine human-legible AI output with strict machine-usable data structures.

The server uses the state-based-adjustment module to adjust target information based on user state information. The server receives user state information such as workload index, stress estimate, or engagement level from sensors, questionnaires, or terminal-side applications that monitor user interactions. The server stores this state information as time-stamped records with normalized values. The state-based-adjustment module defines transformation functions that map ranges of state values to adjustment coefficients for numerical targets and qualitative targets. For example, if the workload index exceeds a defined threshold, the module reduces the growth-rate coefficient applied to production targets. The server then recalculates the numerical target information by multiplying previous targets by the adjustment coefficients. This processing occurs within the goal-management program and updates the in-memory target-management information without requiring full recomputation of aggregated operation data, which reduces processing time and database access load.

The server uses a neural-network-based classifier, in one variation, to infer user state information from features derived from interaction-operation information at the terminal. The classifier is implemented as a feed-forward or recurrent neural network with an input layer receiving features such as typing speed, error rate, time intervals between UI events, and time spent on reviewing each goal item. The network includes one or more hidden layers with nonlinear activation functions, and an output layer that produces probabilities of discrete state labels (for example, “low stress,” “moderate stress,” “high stress”). The server trains this classifier in advance using labeled interaction logs and a supervised learning procedure. The server defines an error function such as cross-entropy between predicted and true labels, and uses gradient descent or a variant thereof to update the network weights. During operation, the server feeds live interaction features to the classifier, obtains a predicted state label, and uses the label as part of the state information for adjusting goals. This implementation goes beyond manual estimation by transforming user interaction patterns into machine-interpretable state signals, thereby enabling automated and fine-grained adaptation of targets.

The terminal operates as a user interface device that communicates with the server over the network. The terminal includes a processor, memory, a display, and input devices such as a touch panel. The terminal executes a client application that requests target-management information from the server and displays it in a structured format. The terminal renders the numerical targets, qualitative targets, and compliance targets in separate sections and provides editing controls for each field. When the user modifies a target, the terminal constructs modification information records that include identifiers of the edited goals, new values, and optional comments. The terminal transmits these records to the server using a structured data format over a secure communication channel.

The user interacts with the terminal to review the server-generated targets and to apply domain knowledge to adjust them. The user reads the explanation of each goal, edits numerical values if operational constraints require it, and reformulates qualitative target descriptions to better match individual development priorities. The user may also choose to accept or reject specific AI-suggested goals. The user then confirms the goal set, causing the terminal to send the final modification information to the server.

The server updates the target-management information stored in the database by applying the received modification information. The server preserves the relationship among original AI-generated target-candidate information, automatically computed numerical targets, and user-modified targets by maintaining versioned records and linking them via identifiers. This versioning mechanism allows the server to compare different generations of goals over time, to measure the effect of previous adjustments, and to refine subsequent prompt-generation and adjustment rules.

The server, in some embodiments, further generates machine-operable configuration data for the industrial equipment based on the finalized numerical and compliance targets. For example, the server may compute recommended production schedules or maintenance intervals and encode them as parameter sets that can be uploaded to controller devices of the industrial equipment. By generating these configuration data sets directly from the integrated targets, the server reduces the need for human operators to manually translate abstract goals into low-level machine settings. This linkage from high-level targets to low-level equipment configurations provides a direct technical effect on the operation of the industrial equipment, such as more consistent maintenance timing and smoother production load distribution.

The server improves computer technology in several ways. First, by using table-format information processing to aggregate operation data and by applying vectorized arithmetic operations, the server reduces the computational complexity of target calculations, which leads to shorter processing times and reduced CPU usage. Second, by generating standardized prompt sentences from structured data and by caching prompt patterns, the server reduces redundant network calls to the external generative AI service, thereby reducing communication load and latency. Third, by converting unstructured AI output into structured target-management information and by version-controlling modifications, the server enhances data consistency and traceability across multiple goal-generation cycles. Fourth, by employing a dedicated neural network to infer user state from interaction signals and by defining adjustment functions that map state information to goal-modification coefficients, the server performs an adaptive control of goal parameters that is not achievable by simple rule-based or manual processes.

The server further differs from mere automation of a human process because the goal-management program implements specific, non-conventional data structures and processing flows optimized for machine execution. For example, the integration of operation metrics, user attributes, and regulation constraints into a single standardized prompt sentence is not a simple transcription of human reasoning but a machine-optimized encoding designed to maximize information density while maintaining token limits for the generative AI model.

The server selects and orders data elements in the prompt according to empirically determined contributions to predictive quality, and may dynamically omit low-value features to reduce token count, which is a form of computational resource optimization. In an alternative embodiment, the server employs different generative AI models with specialized architectures or training data. For instance, the server may use a transformer model fine-tuned on domain-specific maintenance reports and goal-setting documents.

During fine-tuning, the server or an associated training system uses supervised learning with pairs of context descriptions and desired goal outputs, defines a loss function measuring the discrepancy between generated and reference goals, and adjusts the model parameters via backpropagation. Such a fine-tuned model can produce more accurate and contextually appropriate target-candidate information, thereby reducing the need for post-processing corrections. The server can also implement ensemble strategies in which outputs from multiple generative models are combined or ranked according to internal scoring metrics, further improving accuracy and robustness.

In another variation, the server integrates a rule-based post-processing module that verifies the AI-generated target-candidate information. This module applies domain-specific constraints, such as maximum safe utilization percentages or minimum regulatory inspection frequencies, to each proposed goal. When a violation is detected, the module automatically adjusts the proposed values to the nearest permitted range and records the adjustment. This automatic correction mechanism reduces the occurrence of invalid configurations and thus lowers the error rate in subsequent equipment control or scheduling processes.

Because the server organizes data in well-defined tables and structures, sequences the processing through distinct modules, and applies non-trivial algorithms including neural inference, vectorized aggregation, and rule-based constraint checking, the overall system achieves improved processing speed, accuracy, and reliability compared to conventional human-centric or ad hoc computerized goal-setting procedures. The technical effects include reduced processing latency in goal generation, reduced communication overhead with external AI services due to caching and standardized prompting, improved correctness of compliance targets due to rule-based extraction and verification, and more precise adaptation of goals to user conditions through machine-learning-based state estimation.

The terminal and the user, in cooperation with the server, thus operate within a technically integrated environment where industrial equipment operation data, personal capability data, and regulatory constraints are transformed into actionable and machine-validated goals. By tightly coupling generative AI outputs with structured data management and adaptive algorithms, the system enables a concrete improvement in the way computing resources are used to support and control real-world equipment operation.

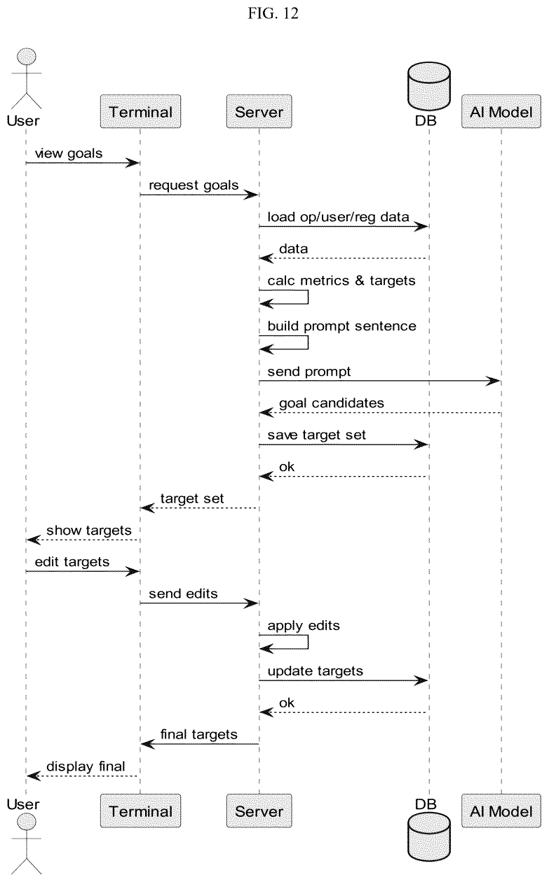

The following describes the processing flow using FIG. 12.

### Step 1:

The server acquires raw operation information of industrial equipment from a storage device and converts it into a table-format structure.

The server receives, as input, records including equipment identifiers, time stamps, production quantities, downtime durations, and maintenance flags. The server executes a query to the storage device, loads the result into a table (for example, a data frame), and converts time-stamp strings into time objects, numeric strings into numeric types, and missing values into predefined default values. Based on this input, the server performs data-type conversion, filtering by target period, and sorting by time. The server outputs a cleaned operation table in which each row represents an operation event and each column represents a standardized attribute.

### Step 2:

The server aggregates the cleaned operation information by period and calculates growth-rate information and achievement-rate information.

The server receives, as input, the cleaned operation table from Step 1 and target records from a target-information table that include previous-period target information and current performance information. The server groups the operation table by period (for example, by month or quarter), applies aggregation functions such as sum of production quantities and count of maintenance events, and generates an aggregated table. The server then, for each period, divides current actual values by corresponding target values to compute achievement-rate information and subtracts or divides previous actual values by earlier-period values to compute growth-rate information. The server outputs an aggregated metrics table that contains, for each period and each equipment, total production, maintenance counts, growth-rate values, and achievement-rate values.

### Step 3:

The server determines numerical target information for a next period based on the aggregated metrics.

The server receives, as input, the aggregated metrics table from Step 2 and rule parameters for target calculation such as desired growth coefficients, maximum allowed increases, and safety margins. The server applies arithmetic operations that multiply previous-period metrics by growth coefficients and then clamps the results within allowed ranges using minimum and maximum functions. For example, the server multiplies last period's production quantity by a growth coefficient (for example, 1.10) and limits the result to not exceed a maximum capacity value. The server outputs a numerical-target table that includes proposed target production quantities, target maintenance frequencies, and other numerical targets for the next period.

### Step 4:

The server acquires user attribute information and constructs a structured user profile representation.

The server receives, as input, user identifiers and accesses multiple tables in the storage device including skill information, career information, and evaluation information. The server joins these tables based on user identifiers, sorts career events chronologically, and calculates statistics such as average evaluation scores and counts of completed training sessions. The server then compresses the joined records into a profile object that contains lists of skills, summarized career paths, and key performance indicators. The server outputs a structured user profile for each user, ready for insertion into a prompt sentence.

### Step 5:

The server acquires regulation information and derives compliance target information.

The server receives, as input, equipment-type identifiers and region codes and queries a regulation-information store holding law information and rule information. The server retrieves text documents corresponding to applicable laws and internal rules, then scans the text using pattern-matching rules to detect expressions that specify mandatory frequencies, deadlines, or upper/lower limits (for example, “at least once every three months” or “not more than eight hours of continuous operation”). Based on this input, the server extracts numbers, time units, and action verbs, and maps them into structured compliance-target entries with fields such as required action, frequency, and deadline. The server outputs a compliance-target table that lists regulation-derived goals linked to each equipment type and region.

### Step 6:

The server integrates numerical target information, user attribute information, and compliance target information into unified integrated target information.

The server receives, as input, the numerical-target table from Step 3, the user profiles from Step 4, and the compliance-target table from Step 5. The server matches records by user identifiers, equipment identifiers, and period identifiers, and merges them into a combined structure. The server resolves conflicts by applying precedence rules, for example, ensuring that compliance-required minimum maintenance frequencies override lower numerical suggestions. The server outputs integrated target information that includes, for each user-equipment-period combination, a set of numerical targets, qualitative context from the user profile, and compliance constraints.

### Step 7:

The server generates a prompt sentence for a generative AI model based on the integrated target information and historical context.

The server receives, as input, the integrated target information from Step 6 and selected historical metrics such as previous-period production and maintenance values from the aggregated metrics table. The server inserts these values into a predefined text template with explicit slots for production quantities, maintenance frequencies, user skills, career goals, and regulation summaries. The server concatenates text fragments in a fixed order and formats numbers with units (for example, “1000 parts,” “1.5 times per month”). The server outputs a prompt sentence as natural-language text that encodes the context in a structured and machine-generated form.

### Step 8:

The server transmits the prompt sentence to an external generative AI model and receives target-candidate information.

The server receives, as input, the prompt sentence from Step 7 and AI-inference parameters such as maximum output length and randomness controls. The server formats the prompt sentence into a request payload, encodes it into tokens using a tokenizer, and sends the tokens to an external information processing service that implements a generative AI model. The generative AI model, internally, processes the tokens and returns output tokens representing proposed numerical and qualitative goals. The server decodes the returned tokens into text.

The server outputs AI-generated target-candidate text that contains proposals for refined numerical targets and qualitative self-improvement objectives.

### Step 9:

The server parses the AI-generated target-candidate text into structured target-candidate information.

The server receives, as input, the AI-generated target-candidate text from Step 8. The server applies parsing rules based on separators, keywords such as “Numerical goal:” and

“Qualitative goal:”, and line breaks. The server splits the text at these markers, extracts numeric values by scanning for digit patterns and units, and assigns categorical labels such as goal type and priority. Using these operations, the server converts unstructured sentences into a list of goal records with fields like description, value, and type. The server outputs a structured target-candidate set that can be merged with other goal data.

### Step 10:

The server generates target-management information by combining integrated target information with structured target-candidate information.

The server receives, as input, the integrated target information from Step 6 and the structured target-candidate set from Step 9. The server aligns AI-generated candidates with existing numerical, qualitative, and compliance entries by comparing descriptors and categories. If an AI-generated target refines an existing numerical target, the server stores both original and AI-suggested values and calculates a difference as an additional field. The server organizes all entries into a target-management record including metadata such as user identifiers, period identifiers, and version numbers. The server outputs target-management information, which serves as a comprehensive data structure for subsequent interaction and adjustment.

### Step 11:

The server transmits the target-management information to the terminal, and the terminal presents the information to the user.

The server receives, as input, a request from the terminal that includes a user identifier and a target period. The server retrieves corresponding target-management information from storage, serializes it into a transferable format, and sends it to the terminal via a communication interface. The terminal receives the serialized data as input, parses it into local data structures, and renders the numerical targets, qualitative targets, and compliance targets on a display. The terminal generates UI elements such as text fields and sliders based on the types and ranges in the data. The terminal outputs visual screens and interactive controls that allow the user to view and modify each target.

### Step 12:

The user reviews the presented targets on the terminal and generates modification information.

The user receives, as input, the visible target-management information shown on the terminal, including AI-suggested goals and original computed targets. The user compares those goals with operational constraints, personal capabilities, and on-site conditions, and then edits numerical values or rewrites qualitative descriptions using the terminal's input interface. The user may, for example, change “1100 parts” to “1050 parts” or alter a qualitative goal to focus on a different skill area. As a result of these interactions, the user produces edits that the terminal records as modification information containing goal identifiers, old values, and new values. The user triggers submission, and the terminal outputs this modification information to the server.

### Step 13:

The terminal transmits modification information to the server, and the server updates the target-management information.

The terminal receives, as input, the modification information generated in Step 12. The terminal packages this information into a request payload and sends it to the server over the network. The server receives the payload as input, validates goal identifiers and value ranges, and applies the modifications to the corresponding records in the target-management information. The server recalculates any dependent values (for example, recalculated growth-rate targets) and updates version numbers to reflect a new finalized state. The server outputs updated target-management information that reflects both AI-generated suggestions and user adjustments.

### Step 14:

The server obtains user state information and adjusts at least one of the numerical and qualitative targets accordingly.

The server receives, as input, user state information derived from sensors, questionnaires, or interaction logs, including indicators such as workload, stress, or engagement. The server maps these indicators into normalized scores and then applies predefined adjustment functions, such as multiplying production targets by a factor less than one when workload is high. The server also adjusts qualitative targets by adding or emphasizing objectives related to stress reduction or time management if the state scores indicate such needs. Based on these computations, the server updates target fields in the target-management information and may store an adjusted version distinct from the unadjusted one. The server outputs state-adjusted goal data that better match the current user condition.

### Step 15:

The server provides finalized targets for use in planning and control of industrial equipment, and the user operates the equipment based on these targets.

The server receives, as input, a request for finalized goals from a planning or control module or from the terminal. The server selects the latest version of the target-management information, including user modifications and state-based adjustments, and extracts the numerical and compliance-related targets relevant to equipment operation. The server converts these targets into machine-usable parameters such as recommended production schedules or maintenance intervals and, if necessary, transmits them to equipment controllers or planning systems. The user receives, via the terminal or local control panels, these recommended parameters and configures the industrial equipment accordingly. The server outputs configuration data and target references that guide real-world operation, and the user's operation produces new operation information that will be collected and used as input in subsequent processing cycles.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional goal-setting systems for management-by-objectives (MBO) are typically implemented as simple form-based applications that store user-entered targets in a database. Such systems generally lack an intelligent mechanism to analyze historical performance information, user attribute information, and norm information in an integrated manner, and therefore cannot automatically propose appropriate numerical goals, qualitative goals, and compliance goals. As a result, users and administrators must manually interpret past performance data, manually translate abstract self-development intents into concrete qualitative goals, and manually map legal and regulatory requirements into compliance goals, which leads to inconsistent goal quality, high cognitive load, and operational inefficiency. Furthermore, in many existing systems that incorporate computational models or rule engines, the input interface to any advanced model is rigid and narrowly defined. These systems often do not exploit free-form natural language from users as a rich source of intent, and do not construct structured, model-oriented prompt information from multiple heterogeneous data sources. Consequently, generative models, when used, are typically driven by ad hoc or static prompts that ignore history information, user information, and norm information, which results in low-quality outputs and limited adaptability to different user contexts.

In addition, even when generative AI models are integrated, conventional architectures often treat the model as a one-shot text generator without a structured feedback cycle. Existing systems frequently do not manage user feedback as first-class structured data, do not iteratively update prompt information over multiple interaction cycles, and do not version-control the evolving MBO goal proposals. As a result, it is difficult to provide traceable, auditable, and systematically improved goal proposals, and the system cannot effectively support interactive refinement of goals under enterprise governance requirements. Moreover, many known systems do not take into account user emotion-state information when adjusting numerical goals and qualitative goals. These systems therefore fail to adapt goal difficulty and content to the user's emotional state, which can lead to targets that are either overly aggressive or insufficiently challenging, and which in turn may degrade user engagement and system effectiveness. In particular, there is no unified mechanism that analyzes emotion-state information together with dialogue-history information and user-feedback information, and that dynamically adjusts MBO goal proposals within a technical framework that is robust and repeatable.

From a computer-technology perspective, there is a need for an improved server-side architecture and processing method that: (i) acquires and fuses multiple categories of information, including history information, user information, and norm information, into structured prompt information; (ii) controls a generative AI model to automatically extract and reconstruct numerical-goal information, qualitative-goal information, and compliance-goal information; (iii) manages iterative user feedback and dialogue history to generate revision-prompt-sentence information over multiple cycles; (iv) performs version management of MBO goal proposal information; and (v) analyzes emotion-state information in combination with user-feedback information to technically adjust generated goal data. There is a further need to provide such functionality as concrete, repeatable processing executed by a server, so as to improve the operation of a computing system itself, including data structures, model-invocation flows, and state management for AI-driven goal-setting.

The specific processing by the specific processing unit 290 of the data processing device 12 in Example 2 is realized by the following means.

The present invention provides a server comprising a processor and a memory storing instructions that, when executed by the processor, cause the processor to acquire history information including previous-period goal information and current performance information, calculate growth-rate information and achievement-rate information based on the history information, acquire user information including user attribute information and job information, and set qualitative-goal information for self-development based on the user information, acquire norm information including statute information related to work and internal rule information, and set compliance-goal information based on the norm information, automatically set numerical-goal information including comparison conditions with a previous period based on the growth-rate information and the achievement-rate information, generate structured prompt-sentence information by integrating a plurality of kinds of information including the history information, the user information, the norm information, and user-feedback information, and generate a prompt sentence for automatically generating management-by-objectives goal proposal information based on a goal-management method, input the prompt-sentence information including a user input sentence acquired via a terminal into a generative AI model, cause the generative AI model to analyze the prompt-sentence information and automatically generate MBO goal proposal information including the numerical-goal information, the qualitative-goal information, and the compliance-goal information, perform document-generation processing by using the generative AI model so as to convert the MBO goal proposal information into goal-document information in natural language, associate the user-feedback information acquired via the terminal with the MBO goal proposal information and the prompt-sentence information, sequentially update revision-prompt-sentence information in response to a plurality of items of the user-feedback information, input the revision-prompt-sentence information into the generative AI model so as to dynamically regenerate and version-control the MBO goal proposal information, analyze emotion-state information of a user and dialogue-history information, and adjust the numerical-goal information and the qualitative-goal information based on the emotion-state information and the user-feedback information, and hold the MBO goal proposal information and version-management information thereof as record information and output finalized MBO goal information to another business-processing system. This enables an improved computer-implemented goal-setting process in which the server constructs and maintains structured prompt information from heterogeneous data sources, tightly orchestrates interactions with a generative AI model, technically manages iterative feedback and versioning of generated goal data, and adaptively adjusts numerical and qualitative goals based on emotion-state analysis, thereby enhancing the efficiency, consistency, and technical robustness of AI-driven MBO goal generation and adjustment.

The term “history information” refers to information including previous-period goal information and current performance information that is stored in a storage apparatus and used by the processor to calculate growth-rate information and achievement-rate information.

The term “previous-period goal information” refers to information indicating numerical or qualitative targets that were set for at least one prior evaluation period for a user or an organizational unit.

The term “current performance information” refers to information indicating actual results, metrics, or outcomes for a present evaluation period corresponding to the previous-period goal information.

The term “growth-rate information” refers to information representing a rate of increase or decrease between values in the previous-period goal information or previous performance information and values in the current performance information.

The term “achievement-rate information” refers to information indicating a degree of attainment of one or more goals, typically expressed as a ratio or percentage of actual performance relative to target values.

The term “user information” refers to information associated with a user, including at least user attribute information and job information, that is used by the processor to set qualitative-goal information.

The term “user attribute information” refers to information such as role, seniority, skill level, or other profile attributes associated with a user in a goal-management system.

The term “job information” refers to information indicating a user's job type, job responsibilities, organizational affiliation, or position within an organization.

The term “qualitative-goal information” refers to information defining goals related to self-development or skill improvement that are expressed in non-numerical, qualitative form.

The term “self-development” refers to activities or objectives directed toward improving a user's skills, knowledge, competencies, or professional capabilities.

The term “norm information” refers to information including statute information related to work and internal rule information that constrains or guides goal setting from a compliance standpoint.

The term “statute information” refers to information describing external legal requirements, such as laws and regulations, that are applicable to activities covered by the goals.

The term “internal rule information” refers to information describing internal policies, guidelines, standards, or rules defined by an organization.

The term “compliance-goal information” refers to information defining goals that are intended to ensure conformity with statute information and internal rule information.

The term “numerical-goal information” refers to information defining goals by numerical values, including comparison conditions with a previous period, such as percentages or absolute target numbers.

The term “comparison conditions with a previous period” refers to conditions specifying how a numerical goal for a current period is related to a numerical value for a previous period, including relative changes such as increases or decreases.

The term “prompt-sentence information” refers to information including at least one prompt sentence, which may include a user input sentence and structured information, that is provided as input to a generative AI model.

The term “prompt sentence” refers to a natural-language sentence or sequence of sentences that instructs or conditions a generative AI model to produce goal-related output.

The term “user input sentence” refers to a natural-language sentence entered by a user via a terminal, expressing desired goals, constraints, or feedback.

The term “generative AI model” refers to a machine-learned model configured to generate text or structured data by processing prompt-sentence information according to learned statistical patterns.

The term “MBO goal proposal information” refers to information representing a candidate set of management-by-objectives goals, including at least numerical-goal information, qualitative-goal information, and compliance-goal information.

The term “goal-management method” refers to a management-by-objectives methodology in which goals are defined, documented, and evaluated for users or organizational units.

The term “goal-document information” refers to information representing MBO goal proposal information in a human-readable natural-language format suitable for presentation to a user.

The term “document-generation processing” refers to processing that converts structured goal-related information into natural-language goal-document information by using a generative AI model or other text-generation mechanism.

The term “user-feedback information” refers to information entered by a user via a terminal that indicates corrections, additional requirements, evaluations, or adjustments with respect to MBO goal proposal information.

The term “revision-prompt-sentence information” refers to prompt-sentence information that is generated by combining at least MBO goal proposal information, prompt-sentence information, and user-feedback information, and that is used to cause a generative AI model to regenerate or revise goals.

The term “structured information” refers to information organized in a predefined format, such as key-value pairs, tables, or hierarchical data structures, which can be directly processed by a program or a generative AI model.

The term “dialogue-history information” refers to information representing a sequence of interactions between the user and the system, including past user input sentences, system responses, and past user-feedback information.

The term “emotion-state information” refers to information representing an estimated emotional state of a user, derived from input data such as text, voice, or interaction patterns, and used to adjust goal-related information.

The term “version-management information” refers to information indicating different versions of MBO goal proposal information, including identifiers, timestamps, and relationships between versions.

The term “record information” refers to information stored in a storage apparatus for later retrieval, including at least MBO goal proposal information and version-management information.

The term “finalized MBO goal information” refers to information indicating an approved and confirmed set of MBO goals that has been fixed as a final version for a given period.

The term “business-processing system” refers to an information-processing system that performs business-related processing, such as human-resources management, performance evaluation, or workflow management, and that receives finalized MBO goal information from the server.

The term “terminal” refers to an information-processing device operated by a user, such as a client device or user interface device, that transmits user input sentences and user-feedback information to the server and receives goal-document information.

The term “server” refers to an information-processing apparatus comprising at least a processor and a memory, configured to execute instructions for performing the acquisition, analysis, generation, adjustment, and storage of goal-related information as described.

The term “analyze,” when used with respect to the generative AI model or the processor, refers to performing computational operations on input data so as to extract, classify, interpret, or transform elements of the data in accordance with predefined or learned rules.

In one embodiment, a server implements a goal-generation system by executing a computer program stored in a memory. The server comprises at least one general-purpose processor, a main memory, a non-volatile storage apparatus, and a network interface. The server executes an operating system such as a general-purpose server operating system, and middleware such as a web application framework and an application server. The server communicates with one or more terminals via a network such as the Internet or an intranet.

The terminal comprises an information-processing device such as a personal computer, a tablet device, or a smartphone. The terminal executes a web browser or a native application.

The terminal provides a graphical user interface including an input area for a prompt sentence, an input area for user-feedback information, and display areas for goal-document information. The terminal transmits user input to the server using a communication protocol such as HTTPS and receives response data in a structured format such as JSON.

The user operates the terminal to access a web page or application screen provided by the server. The user inputs a prompt sentence describing desired goals, such as numerical targets, qualitative self-development objectives, and compliance-related conditions. For example, the user may input a prompt sentence such as:

“I want to set a sales target that is 10% higher than last year, include a qualitative goal for self-development in digital marketing, and add a compliance goal regarding data protection regulations.”

or

“For the next quarter, I want to reduce operational errors by 5% compared to the previous quarter, strengthen my self-development in data analysis, and ensure full compliance with internal information security policies.”

The server stores such prompt sentences in a storage apparatus as part of history information together with user identifiers, timestamps, and context information.

The server uses a data structure including multiple logical tables in a relational database management system. The server maintains at least a history-information table, a user-information table, a norm-information table, an MBO-goal-proposal table, a feedback-log table, and a version-management table. Each table has defined fields to store structured information. For example, the history-information table stores previous-period goal information and current performance information, each associated with a user identifier and a period identifier. The user-information table stores user attribute information and job information, such as role, department, and skill level. The norm-information table stores statute information and internal rule information, indexed by category identifiers and jurisdiction or policy identifiers. The MBO-goal-proposal table stores numerical-goal information, qualitative-goal information, compliance-goal information, and a version identifier. The feedback-log table stores user-feedback information and links it to corresponding MBO-goal-proposal entries and dialogue-history information. The version-management table manages relationships among multiple versions of proposals and finalized MBO goal information.

The server acquires history information from the history-information table and computes growth-rate information and achievement-rate information by using numerical operations performed by the processor. The server uses, for example, floating-point arithmetic implemented by a numerical library to calculate ratios of current performance information to previous-period goal information. The server stores the resulting growth-rate information and achievement-rate information in memory as part of a structured representation that also includes identifiers of the associated goals and periods.

The server acquires user information from the user-information table. The server determines qualitative-goal information for self-development by mapping user attribute information and job information to categories of qualitative goals. The server maintains a template library of qualitative goals, implemented as a data structure mapping combinations of role, skill level, and career-path attributes to qualitative-goal categories and standardized descriptions. The server selects one or more template entries based on the user information and generates initial qualitative-goal information.

The server acquires norm information from the norm-information table. The server identifies applicable statute information and internal rule information by evaluating conditional rules that reference job information, organizational unit information, and jurisdiction information.

The server then generates compliance-goal information by associating selected statute information and internal rule information with standardized compliance goal patterns stored in a compliance template library.

The server constructs numerical-goal information by combining growth-rate information and achievement-rate information with previous-period goal information. The server determines target values and comparison conditions with a previous period by executing arithmetic operations such as scaling previous-period target values by a growth-rate factor, and by setting thresholds based on organizational policies. The server stores numerical-goal information as structured data including fields for base values, target values, percentage change, and time period identifiers.

The server generates structured prompt-sentence information by integrating the history information, user information, norm information, numerical-goal information, qualitative-goal information, and compliance-goal information. The server uses an intermediate representation such as a key-value map, and then renders a natural-language prompt sentence according to a predefined template. For example, the server may construct a prompt sentence of the form:

“Analyze the following user prompt and the associated context. Previous-period goal: [value]. Current performance: [value]. User role: [role]. Relevant regulations: [list]. Extract and refine (1) numerical goals, (2) qualitative self-development goals, and (3) compliance goals. Return structured JSON fields numerical_goal, qualitative_goal, and compliance_goal.”

By merging multiple sources into a single structured prompt, the server initializes the generative AI model with more complete context and reduces the need for ad hoc user instructions.

The server comprises a generative AI model implemented, for example, as a transformer-based neural network. The server may deploy a large language model with multiple self-attention layers, feedforward layers, and layer-normalization components. The server stores model parameters, including weight matrices, bias vectors, and normalization parameters, in a model storage area of the memory. The server loads the model into a computation framework such as a tensor-computation library capable of exploiting vectorized instructions and hardware accelerators such as graphics-processing units or tensor-processing units.

The server trains or fine-tunes the generative AI model by using training data that pairs prompt-sentence information with target outputs representing desired goal structures. The server uses a training procedure involving mini-batch stochastic gradient descent or a variant such as Adam. The server defines a loss function such as a cross-entropy loss over predicted tokens or structured labels. The server computes gradients of the loss function with respect to model parameters by backpropagation, and updates the parameters according to learning-rate schedules. The server may apply regularization methods such as dropout or weight decay to improve generalization. The server may also perform data augmentation by paraphrasing training prompt sentences or by injecting synthetic variations of history information and norm information, thus enabling the model to handle diverse real-world inputs.

The server processes incoming prompt-sentence information by encoding tokens into embeddings, propagating them through the transformer layers, and generating context-dependent representations for each token. The server decodes output tokens or structured labels based on these representations. The server constrains the output format by including system instructions and few-shot examples in the prompt sentence, causing the model to emit structured representations of numerical goals, qualitative goals, and compliance goals. The server validates and parses the output, mapping it into the MBO-goal-proposal table.

The server uses a rule-based post-processing module in combination with the generative AI model. The server executes non-conventional steps by applying a hybrid approach in which the generative AI model generates candidate goal texts and structured attributes, and a deterministic rules engine verifies and refines them according to numerical ranges, regulatory mappings, and organizational standards. This combination improves computational robustness by reducing the variance of purely model-generated outputs and constraining them to technically consistent values and references.

The server estimates emotion-state information of the user by analyzing user input and interaction patterns. The server may use a second neural network model or a specialized classifier operating on textual or behavioral features. For textual features, the server computes embeddings of user-feedback sentences and prompt sentences, and passes them to a smaller classifier network trained to output emotion labels such as “stressed,” “overwhelmed,” or “confident.” For behavioral features, the server may input timing between keystrokes, frequency of corrections, or repeated revisions into feature vectors and classify these vectors using a trained model. The server stores emotion-state information in an emotion-state table linked to dialogue-history information.

The server adjusts numerical-goal information and qualitative-goal information based on emotion-state information. For example, if the server detects a high level of user stress, the server may apply a constraint that reduces target increases by a specified factor or prioritizes qualitative goals that emphasize sustainable self-development rather than aggressive performance increases. The server performs such adjustments through explicit algorithms using thresholds, scaling factors, and decision rules stored in configuration data, rather than by relying solely on human judgment. This processing modifies internal goal representations and causes the system to generate technically adapted proposals.

The server manages revision-prompt-sentence information by constructing successive prompts that incorporate not only the original prompt sentence and the current MBO-goal-proposal information, but also user-feedback information and dialogue-history information.

The server maintains a dialogue-history data structure that records each exchange, including prompt sentences, model outputs, user feedback, and emotion-state evaluations. When the user inputs new feedback, the server generates a new revision-prompt sentence that explicitly describes differences between the current proposal and requested changes. This procedure provides the generative AI model with precise contextual cues and supports stable iterative refinement.

The server version-controls MBO-goal-proposal information by incrementing version identifiers whenever a new proposal is generated. The server stores relationships between versions in the version-management table, including parent-version identifiers and change summaries. The server allows the terminal to request a specific version or to compare versions for audit purposes. This data management mechanism improves traceability and enables reproducible reconstruction of the system's behavior over time.

The terminal displays goal-document information generated by the server. The terminal renders separate sections for numerical goals, qualitative goals, and compliance goals, and may also present explanations of how each goal relates to history information, user information, and norm information. The terminal may display additional indicators corresponding to emotion-state information or adjustment reasons, allowing the user to understand why certain targets were softened or strengthened.

The user reviews displayed goal-document information and enters user-feedback information through input fields. The user may specify corrections such as “Change the qualitative goal to focus on self-development for digital marketing skills” or “Adjust the sales increase from 10% to 8% to match market conditions.” The terminal transmits the user-feedback information together with identifiers of the current MBO-goal-proposal version to the server.

The server records the feedback in the feedback-log table and constructs revision-prompt-sentence information accordingly.

The server thereby implements a non-conventional workflow that differs from a mere automation of human goal-setting. By integrating structured data from history information, user information, and norm information into prompt-sentence information, and by using a transformer-based generative AI model with iterative revision prompts and emotion-state adjustments, the server improves computational accuracy and consistency of generated goals compared to manual or simple rule-based systems. The server reduces communication load by encoding rich context into compact prompt sentences rather than transmitting large datasets between modules, and by reusing previously stored history information and norm information without repeated retrieval from external sources. The server increases processing speed by executing vectorized neural network inference on hardware accelerators and by performing arithmetic and rule-based refinements locally, thereby reducing the need for repeated user interactions.

The server further improves data management by maintaining version-controlled MBO-goal-proposal information linked to dialogue-history information and emotion-state information. This structure allows the server to re-use previous proposal patterns as input features or training data for further fine-tuning of the generative AI model, leading to progressive accuracy gains over time. The hybrid architecture in which the generative AI model performs semantic extraction and synthesis, while dedicated modules handle numerical computation, compliance mapping, and emotion-based adjustment, constitutes an improvement to computer technology by defining a specific, technical data flow and control structure that is not present in conventional form-based goal-setting applications.

In alternative embodiments, the server may use different neural network architectures, such as encoder-decoder transformers or recurrent neural networks for the emotion classification component, while maintaining the same structured data flow and version management mechanisms. The server may also employ different storage architectures, such as a document-oriented database for dialogue-history information and a relational database for numerical-goal information, as long as the server maintains linkable identifiers and supports the structured integration of history information, user information, and norm information into prompt-sentence information.

In still another embodiment, the server may host multiple generative AI models with different parameter sizes or specializations. The server may select a model according to conditions such as available computational resources, expected complexity of the prompt sentence, or required response time. For simple prompts, the server may use a smaller, faster model, while for complex prompts requiring detailed compliance analysis, the server may use a larger model. This model-selection control logic contributes to improved computational efficiency and reduced latency, and thus represents a technical optimization of resource utilization within the goal-generation system.

By configuring the server, the terminal, and the data structures as described above, the system enables a practitioner to implement and operate the invention in a reproducible manner. The overall design achieves technical effects including improved accuracy and consistency of generated goals, reduced processing time and communication overhead, enhanced traceability through structured version management, and adaptive goal adjustment based on emotion-state information, thereby providing an improvement in the functioning of the computer system itself rather than a mere automation of an abstract business practice.

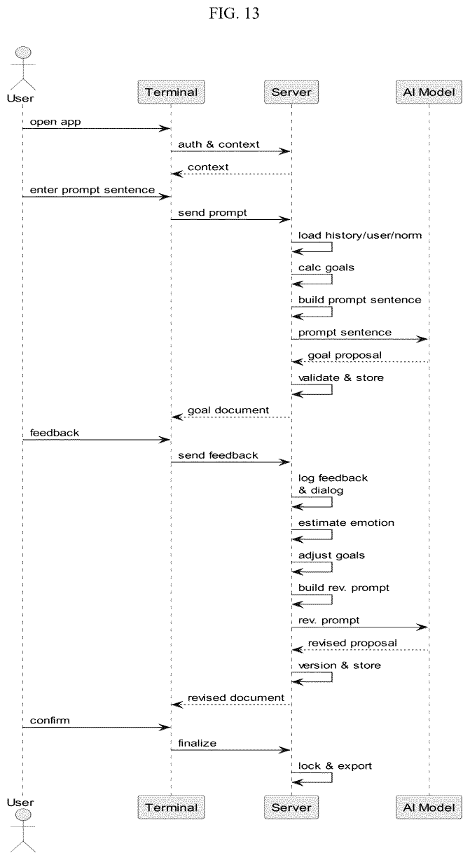

The following describes the processing flow using FIG. 13.

### Step 1:

The terminal displays a login and goal-creation screen to the user and sends an access request to the server.

The terminal receives input such as user identifier, authentication credentials, and a request to open an MBO goal-creation function, and outputs an HTTPS request message containing these values. The terminal converts user keystrokes and button selections into a structured request and transmits it via a network interface.

### Step 2:

The server authenticates the user and loads initial context data.

The server receives the HTTPS request as input and outputs an authentication result and context data. The server validates the user identifier and credentials against an authentication database, and, when successful, reads user information (user attribute information and job information) and history information (previous-period goal information and current performance information) from storage. The server performs database queries and constructs a context object containing user role, department, prior goals, and performance metrics.

### Step 3:

The terminal renders the goal-creation interface using the context data.

The terminal takes the context object from the server as input and outputs a visual user interface. The terminal populates fields such as period selection, role display, and optional suggestion hints, using the received user attribute information and job information. The terminal converts the context object into labels, dropdown menus, and text fields, and displays them on the screen.

### Step 4:

The user inputs a prompt sentence expressing desired goals and conditions.

The user reads the displayed interface as input and outputs at least one prompt sentence, using a keyboard or touch interface. The user may enter, for example, “I want to set a sales target that is 10% higher than last year, include a qualitative goal for self-development in digital marketing, and add a compliance goal regarding data protection regulations.” The user then triggers submission by selecting a send button.

### Step 5:

The terminal transmits the prompt sentence and associated metadata to the server.

The terminal takes the user-entered prompt sentence and local metadata (user identifier, selected period, device timestamp) as input and outputs a structured API request. The terminal validates that the prompt sentence is non-empty and within a defined length, then serializes the data into a JSON payload and sends it via HTTPS to the server.

### Step 6:

The server stores the raw prompt sentence and retrieves related historical and normative data.

The server receives the JSON payload as input and outputs an internal request identifier and a consolidated data bundle. The server writes the raw prompt sentence, user identifier, and timestamp into a prompt-log table. The server then queries the history-information table to obtain previous-period goal information and current performance information, and queries the norm-information table to obtain applicable statute information and internal rule information based on job information and organization. The server packages these data items into a structured context object.

### Step 7:

The server computes growth-rate information and achievement-rate information from history information.

The server takes previous-period goal information and current performance information as input and outputs growth-rate information and achievement-rate information. The server performs numerical operations such as subtracting previous-period values from current-performance values, dividing differences by previous-period values, and converting results to percentages. The server stores these computed values in memory as part of the context object.

### Step 8:

The server determines initial numerical-goal information based on computed rates and policies.

The server takes growth-rate information, achievement-rate information, and policy parameters as input and outputs numerical-goal information. The server applies algorithms that scale previous-period targets by specified multipliers, clamp the results within permitted minima and maxima, and generate comparison conditions with the previous period. The server writes base values, target values, and percentage change into a numerical-goal structure.

### Step 9:

The server determines initial qualitative-goal information and compliance-goal information from user and norm information.

The server uses user attribute information, job information, and template libraries as input and outputs qualitative-goal information. The server matches user role and skill level against a qualitative-goal template table, selects corresponding self-development patterns, and instantiates them with user-specific details. Separately, the server uses statute information and internal rule information as input and outputs compliance-goal information by selecting compliance templates that match applicable regulatory categories and internal policies.

### Step 10:

The server generates structured prompt-sentence information for the generative AI model.

The server takes the raw user prompt sentence, numerical-goal information, qualitative-goal information, compliance-goal information, history information, user information, and norm information as input and outputs a composed prompt sentence. The server formats these data as a combined instruction, for example: “Analyze the following user prompt and context. Previous-period goal: [value]. Current performance: [value]. User role: [role]. Relevant regulations: [list]. Extract and refine numerical, qualitative, and compliance goals.” The server stores this as prompt-sentence information ready for model inference.

### Step 11:

The server executes inference on the generative AI model using the prompt-sentence information.

The server takes the prompt-sentence information as input and outputs model-generated goal structures. The server tokenizes the prompt sentence, encodes tokens into numerical vectors, feeds the vectors through a transformer-based generative AI model with multiple self-attention layers and feedforward layers, and decodes the output sequence. The server constrains the output format to a structured representation containing fields for numerical-goal candidates, qualitative-goal candidates, and compliance-goal candidates.

### Step 12:

The server validates and normalizes the model output into MBO goal proposal information.

The server uses the model-generated goal structures and system rules as input and outputs validated MBO goal proposal information. The server checks that required fields are present, that numerical values are within allowable ranges, and that referenced regulations match entries in the norm-information table. The server normalizes terminology, resolves ambiguities, and converts free-form text into standardized fields, producing a consistent proposal record.

### Step 13:

The server generates goal-document information in natural language.

The server takes the structured MBO goal proposal information as input and outputs human-readable goal-document text. The server may send a secondary prompt sentence to the generative AI model, instructing it to rewrite structured fields into concise sentences, or the server may use predefined templates to assemble the text. The server joins the resulting sentences into sections for numerical goals, qualitative goals, and compliance goals.

### Step 14:

The server stores the MBO goal proposal information with version-management information.

The server takes the validated proposal and current version state as input and outputs updated database records. The server inserts a new row into the MBO-goal-proposal table with a unique proposal identifier and version identifier, and writes corresponding version-management information indicating that this is an initial version. The server links the proposal to the prompt-log entry and to user identifiers.

### Step 15:

The server sends the goal-document information and identifiers to the terminal.

The server uses the goal-document text and proposal metadata as input and outputs an HTTPS response. The server encapsulates numerical-goal sentences, qualitative-goal sentences, compliance-goal sentences, and identifiers into a JSON payload and transmits it to the terminal through the network interface.

### Step 16:

The terminal displays the MBO goal proposal to the user.

The terminal takes the JSON payload as input and outputs a rendered screen. The terminal parses the payload, places the numerical, qualitative, and compliance goal sentences into labeled sections, and displays the proposal identifier and version. The terminal may format text using fonts and colors to distinguish goal types.

### Step 17:

The user reviews the proposal and enters user-feedback information.

The user reads the proposal on the terminal as input and outputs feedback sentences through text fields. The user may input text such as “Change the qualitative goal to focus on self-development in digital marketing and reduce the sales increase to 8% instead of 10%.” The user confirms the feedback by activating a send or adjust control.

### Step 18:

The terminal transmits the user-feedback information and current version to the server.

The terminal uses the feedback text, proposal identifier, and version identifier as input and outputs a feedback API call. The terminal forms a JSON document that includes these items and sends it to a dedicated feedback endpoint on the server via HTTPS.

### Step 19:

The server records the feedback and updates dialogue-history information.

The server takes the feedback payload as input and outputs updated feedback-log and dialogue-history records. The server writes the feedback text, associated proposal identifier, version identifier, and timestamp into the feedback-log table, and appends a corresponding entry in the dialogue-history structure that links the new feedback with previous exchanges and prompt sentences.

### Step 20:

The server estimates emotion-state information based on the feedback and interaction data.

The server uses the feedback text, prior user input, and interaction timing as input and outputs emotion-state information. The server converts the feedback text into embeddings using a neural encoder, feeds these embeddings, together with features such as response latency and edit frequency, into a trained classifier network, and computes probabilities for emotion categories. The server stores the resulting emotion-state label and confidence score in an emotion-state table.

### Step 21:

The server adjusts internal goal parameters in response to emotion-state information.

The server takes the current numerical-goal information, qualitative-goal information, and emotion-state information as input and outputs adjusted goal parameters. The server applies algorithms that modify target percentages, relax or tighten constraints, or change qualitative emphasis based on threshold rules for each emotion category. The server creates updated internal goal structures reflecting these adjustments.

### Step 22:

The server generates revision-prompt-sentence information incorporating feedback and adjustments.

The server uses the original prompt sentence, the current MBO goal proposal, the user-feedback information, the dialogue-history information, and the adjusted goal parameters as input and outputs a revision prompt sentence. The server constructs a natural-language instruction that explicitly describes which elements should be changed, which should remain, and how emotion-state information influenced constraints, and bundles this into structured prompt-sentence information for the generative AI model.

### Step 23:

The server performs a second inference on the generative AI model to regenerate the MBO goal proposal.

The server takes the revision-prompt-sentence information as input and outputs revised goal structures. The server again tokenizes the input, runs it through the transformer network, and decodes a structured representation of revised numerical, qualitative, and compliance goals.

The server ensures that the model output reflects requested changes and internal policies.

### Step 24:

The server validates, version-controls, and stores the revised proposal.

The server uses the revised goal structures and the previous version identifier as input and outputs a new versioned proposal record. The server checks ranges, mappings, and consistency as before, assigns a new version identifier, records parent-version linkage in the version-management table, and inserts the revised MBO-goal-proposal information into the database.

### Step 25:

The server regenerates goal-document information and returns the updated version to the terminal.

The server takes the revised structured goals as input and outputs updated goal-document text and metadata. The server composes updated natural-language sentences, optionally calling the generative AI model for rephrasing, and sends the new proposal as a JSON response to the terminal.

### Step 26:

The terminal updates the display to show the revised MBO goal proposal.

The terminal uses the updated JSON payload as input and outputs a refreshed screen. The terminal replaces previous goal sentences with the new ones, updates the version label, and may visually highlight differences such as changed percentages or reworded qualitative goals.

### Step 27:

The user repeats the feedback cycle or confirms the final proposal.

The user evaluates the revised proposal as input and outputs either further feedback or a confirmation action. If satisfied, the user activates a confirm control indicating that the current version should be finalized.

### Step 28:

The terminal sends a finalization request to the server.

The terminal uses the proposal identifier, version identifier, and user authentication token as input and outputs a confirmation API call. The terminal transmits this call via HTTPS to the server.

### Step 29:

The server finalizes the MBO goal proposal and outputs finalized MBO goal information.

The server takes the confirmation request as input and outputs finalized MBO goal records and optional notifications to external systems. The server updates the status of the specified proposal version to finalized in the MBO-goal-proposal table, locks it against further modification, and records the confirmation time. The server may then package the finalized MBO goal information and send it to another business-processing system for downstream processing or reporting.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional goal management systems in computing environments typically rely on static rule sets or manual configuration to define numeric targets and qualitative objectives. In such systems, a processing unit merely reads past performance values, applies fixed threshold logic, and stores predetermined targets without dynamically integrating heterogeneous information sources such as regulatory data, user capability data, natural language feedback, and real-time emotional state data. As a result, the underlying computer processes remain rigid and inefficient, and the generated goals are often misaligned with actual user context and operational conditions.

Furthermore, traditional systems do not provide a structured mechanism for transforming internal machine-readable target data into optimized natural-language prompt sentences for a generative artificial intelligence model and then reintegrating the generated results back into structured goal representations. In many cases, an operator must manually craft prompts, copy and paste responses, and interpret unstructured text, which increases latency, introduces human error, and prevents the computing system from automatically closing the loop between data acquisition, model invocation, and persistent goal adjustment.

In addition, known architectures generally treat user feedback and emotional state signals as optional annotations rather than as first-class computational inputs. They lack an integrated pipeline in which a processor: (i) collects user feedback via a terminal device; (ii) performs natural language processing to extract explicit adjustment requests; (iii) computes emotional state from multimodal data such as facial images, voice signals, or biological sensor readings; and (iv) algorithmically adjusts numeric and qualitative goals based on a combined evaluation of semantic feedback and emotional state. This absence of an integrated pipeline limits the ability of the computing system to generate context-aware and user-appropriate outputs, and causes the system to require repeated manual intervention to avoid overloading or under-challenging a user or an industrial apparatus.

Moreover, existing systems that control industrial apparatuses or information processing apparatuses based on goals typically perform a one-way mapping from fixed targets to control parameters. They do not periodically re-evaluate goals using a feedback loop that includes newly collected performance data, updated regulation information, evolving capability profiles, and emotional trajectories of human operators. Consequently, these systems cannot adaptively update operation plans or work schedules in a way that is both compliant with regulations and responsive to user condition, thereby reducing overall system robustness and computational effectiveness.

Accordingly, there is a need for an improved computer-implemented system and processing method that: (a) unifies performance data, user capability data, and regulation data into machine-readable goal structures; (b) automatically generates and refines natural-language prompt sentences for a generative artificial intelligence model; (c) automatically converts generative artificial intelligence outputs into structured, machine-usable goal data; (d) algorithmically incorporates user feedback and emotional state into goal adjustment; and (e) automatically propagates dynamically updated goals to industrial apparatuses or information processing apparatuses. Such a system would improve the functioning of the computer itself by providing more efficient data flows, reducing manual prompt engineering, and enabling a closed-loop, adaptive goal management process that is executable solely by the computing infrastructure.

The specific processing by the specific processing unit 290 of the data processing device 12 in Application Example 2 is realized by the following means.

The present invention provides a server comprising a processor configured to acquire previous period target information and current performance information from one or more storage devices, and calculate growth rate information and achievement rate information by executing numerical computation instructions; acquire capability information and job-path information of a user from a data store, compare the capability information with job-requirement information, and set qualitative goal information for self-development based on results of the comparison; acquire regulation information related to work from at least one of an external information source and an internal information source via a communication interface, analyze contents of the regulation information, and set goal information in consideration of regulation compliance based on the content analysis; integrate numeric goal information based on the growth rate information and the achievement rate information, the qualitative goal information, and the goal information in consideration of regulation compliance into an integrated goal data structure in memory; construct, in a natural language, a prompt sentence for a generative artificial intelligence model by formatting the integrated goal data structure into a textual representation; transmit, through a network interface, request information including the prompt sentence to the generative artificial intelligence model, receive response information including target-management proposal information from the generative artificial intelligence model, and store the response information as structured data in the storage devices; receive, from a terminal device operated by the user, opinion information and preference information regarding the target-management proposal information, and execute natural language processing on the opinion information and the preference information to extract numeric goal adjustment request information and qualitative goal adjustment request information; acquire at least one of facial information, voice information, and biological information from the terminal device, apply an emotion estimation model to the acquired information to calculate emotional state information of the user, and execute an adjustment process that increases or decreases, or changes content of, at least one of the numeric goal information and the qualitative goal information by integrally evaluating the emotional state information and the opinion information; generate, again, a prompt sentence including goal information after the adjustment process and the emotional state information, transmit a second request including the prompt sentence to the generative artificial intelligence model, and receive a revised version of the target-management proposal information so as to generate goal information dynamically updated according to the emotional state and feedback of the user; and generate and transmit, to an industrial apparatus or an information processing apparatus via the communication interface, operation condition information or work plan information based on the dynamically updated goal information to update an operation plan of the industrial apparatus or the information processing apparatus. This enables the computer system to automatically perform a closed-loop, adaptive goal management process that (i) transforms heterogeneous operational, regulatory, capability, and emotional inputs into integrated machine-readable goal structures, (ii) leverages a generative artificial intelligence model through automatically constructed prompt sentences without manual intervention, (iii) converts generative outputs back into structured data for further computation, and (iv) propagates dynamically adjusted goals to controlled apparatuses, thereby improving the technical efficiency, responsiveness, and reliability of computer-implemented goal management and control operations.

The term “previous period target information” refers to data indicating one or more goal values or performance targets that were set for a prior time interval, such as a previous day, week, month, quarter, or year, and that are stored in a data storage device for later comparison with current performance.

The term “current performance information” refers to data representing actual operational results or achievements for a current time interval, including measured values such as production quantities, sales amounts, error counts, or completion rates, which are acquired from one or more data sources.

The term “growth rate information” refers to data representing a rate of change between current performance information and previous period target information or previous period performance information, typically expressed as a percentage or ratio computed by numerical operations executed by the processor.

The term “achievement rate information” refers to data representing a degree to which current performance information meets or exceeds previous period target information, typically expressed as a percentage or ratio indicating target attainment.

The term “capability information” refers to data describing skills, competencies, experiences, qualifications, or knowledge possessed by a user, which can be used by the processor to evaluate suitability for specific tasks or roles.

The term “job-path information” refers to data describing a user's career trajectory, role history, or desired future role, including information such as current position, prior positions, and target positions within an organization or activity domain.

The term “job-requirement information” refers to data describing capabilities, experience levels, or conditions required to perform a particular role, task, or job function, and is used as a reference for comparing with capability information.

The term “qualitative goal information” refers to data describing non-numeric objectives related to self-development, behavior, or process improvement, expressed in descriptive or categorical form rather than as specific numeric values.

The term “regulation information” refers to data representing rules, laws, standards, or guidelines applicable to a particular activity, industry, or organization, including obligations, prohibitions, and procedural requirements obtained from external or internal sources.

The term “goal information in consideration of regulation compliance” refers to data describing one or more goals that are generated based on analysis of regulation information so as to support or ensure adherence to applicable rules, laws, standards, or guidelines.

The term “numeric goal information” refers to data representing one or more goal values expressed as numbers, such as target quantities, rates, deadlines, or limits, used to quantitatively evaluate performance.

The term “integrated goal data structure” refers to a combined data representation stored in memory that includes numeric goal information, qualitative goal information, and goal information in consideration of regulation compliance, organized in a unified format for processing by the processor.

The term “prompt sentence” refers to a natural-language text string or sequence of text segments that is generated by the processor and supplied as input to a generative artificial intelligence model in order to instruct the model to produce target-management proposal information or related content.

The term “generative artificial intelligence model” refers to a computational model, such as a machine learning or neural network model, that is configured to generate new data, including natural-language text, based on input data such as a prompt sentence and optionally additional context information.

The term “request information” refers to data transmitted from the server to the generative artificial intelligence model and including at least the prompt sentence and optionally other parameters such as model identifiers, temperature settings, or token limits.

The term “response information” refers to data transmitted from the generative artificial intelligence model to the server in response to the request information and including generated text or structured content such as target-management proposal information.

The term “target-management proposal information” refers to data representing one or more proposed goals, plans, or action items, expressed in natural language or structured form, that are intended to be used in managing objectives for a user, apparatus, or organization.

The term “structured data” refers to data organized into a predefined format, such as records, fields, tables, or objects, enabling deterministic access, querying, and processing by the processor.

The term “terminal device” refers to an electronic device operated by a user, such as a mobile terminal, wearable device, or computing terminal, that is configured to communicate with the server, present information to the user, and acquire user input or sensor data.

The term “opinion information” refers to data representing a user's subjective views, evaluations, or comments about one or more goals or proposals, typically acquired as natural-language text input from the terminal device.

The term “preference information” refers to data representing a user's desired conditions, such as preferred difficulty, workload, timing, or focus areas, related to target setting or goal management.

The term “numeric goal adjustment request information” refers to data extracted from user feedback that specifies or implies a desired change to one or more numeric goal values, such as increasing, decreasing, or rescheduling numeric targets.

The term “qualitative goal adjustment request information” refers to data extracted from user feedback that specifies or implies a desired change to one or more qualitative goals, such as adding, removing, or modifying non-numeric objectives.

The term “facial information” refers to data representing visual features of a user's face, including images, video frames, or feature vectors, obtained by an image-capturing component of the terminal device.

The term “voice information” refers to data representing audio signals of a user's speech, including raw audio, processed signals, or extracted acoustic features, obtained by a sound-capturing component of the terminal device.

The term “biological information” refers to data representing physiological signals of a user, such as heart rate, skin conductance, body temperature, or other biometrics, measured by one or more sensors associated with the terminal device.

The term “emotion estimation model” refers to a computational model configured to infer an emotional state from one or more of facial information, voice information, and biological information, and to output emotional state information.

The term “emotional state information” refers to data indicating an inferred emotional condition of a user, such as stress level, positivity, negativity, or motivation, derived by applying the emotion estimation model to input signals.

The term “adjustment process” refers to a computational procedure executed by the processor to modify, based on specified conditions, at least one of numeric goal information and qualitative goal information by changing values, priorities, or contents.

The term “dynamically updated goal information” refers to goal information that has been modified over time by the adjustment process in response to new inputs, including performance information, feedback information, or emotional state information.

The term “industrial apparatus” refers to a machine, device, or system deployed in an industrial environment, such as a production machine, robot, or process control unit, that operates according to operation condition information or work plan information.

The term “information processing apparatus” refers to a computing device, server, or electronic system that executes information processing tasks under control of operation condition information or work plan information.

The term “operation condition information” refers to data specifying parameter values, limits, modes, or configuration settings that control how an industrial apparatus or an information processing apparatus operates.

The term “work plan information” refers to data describing a schedule, sequence of tasks, assignments, or throughput goals that an industrial apparatus or an information processing apparatus is to perform within a specified time interval.

The term “operation plan” refers to a structured representation combining operation condition information and work plan information that defines how and when an industrial apparatus or an information processing apparatus is to execute operations.

The term “storage devices” refers to one or more hardware components, such as magnetic disks, solid-state drives, or memory units, that are configured to store data including target information, performance information, user information, regulation information, and generated goal information.

The term “communication interface” refers to hardware and software components that enable data exchange between the server and external devices or services, including network interfaces, communication protocols, and associated control logic.

The term “network interface” refers to a specific portion of the communication interface that connects the server to a communication network, and that is configured to send and receive data packets corresponding to request information, response information, and control information.

The term “natural language processing” refers to computational techniques for analyzing, interpreting, and transforming natural-language texts, including tokenization, parsing, semantic analysis, sentiment analysis, and extraction of structured information from unstructured text.

The term “closed-loop, adaptive goal management process” refers to a sequence of computer-implemented operations in which goals are generated, evaluated, adjusted, and re-applied in repeated cycles, using feedback signals such as performance data and emotional state data, without requiring manual re-creation of the process at each cycle.

In one embodiment, a server, a terminal, and a generative AI model cooperate to implement the claimed system. The server includes at least one processor, a main memory, one or more storage devices such as magnetic disks or solid-state drives, and a communication interface such as an Ethernet interface. The terminal includes at least one processor, a display device, an input device, and, in some embodiments, a camera, a microphone, and one or more biological sensors. The generative AI model executes on a model-execution platform, which can be implemented on the same machine as the server or on a remote machine accessible via a communication network.

The server uses general-purpose operating system software and application software to implement the claimed functions. The server, in one example, runs an operating system such as a UNIX-like operating system, and executes middleware such as a relational database management system, and an application runtime such as a scripting runtime or a virtual machine runtime. The server stores target information, performance information, regulation information, capability information, job-path information, and goal information in structured form using a relational database such as a general SQL database. The server uses a data-analysis library such as a numerical computation library and a data-frame library (for example, a library similar to NumPy or Pandas) to perform numerical computations and data transformations.

The terminal runs an operating system such as a mobile operating system, and executes a user interface application developed by a user-interface framework such as a web rendering engine or a native application framework. The terminal communicates with the server over a network such as the Internet using protocols such as HTTPS. In one configuration, the terminal is a smartphone or tablet. In another configuration, the terminal is a wearable device such as smart glasses. The terminal presents screens implemented by a client framework (for example, a framework similar to React or a native UI toolkit) that render forms, lists, and dialogs for user interaction.

The server acquires previous period target information and current performance information from a storage device via the relational database. The server stores such information in tables including fields such as user identifier, period identifier, target value, actual value, and timestamps. The server uses SQL queries to retrieve rows matching a specific user and period. The server then loads the retrieved rows into an in-memory data-frame structure. The server uses a numerical computation library to calculate growth rate information and achievement rate information. For example, the server performs element-wise subtraction and division operations using floating-point arithmetic on vectorized data, and stores results such as growth_rate and achievement_rate in additional columns in the data frame. This vectorized computation avoids repeated row-by-row loops and improves processing throughput and cache utilization compared with naïve implementations.

The server acquires capability information and job-path information of a user from a user-profile data store. The server maintains capability information in a normalized table structure where each record contains a capability identifier, a proficiency level, and a timestamp. The server stores job-path information including historical roles and desired future roles in another table. The server loads these tables into in-memory objects. The server compares the capability information with job-requirement information using a rule engine. The rule engine holds rules specifying, for each role, mandatory capabilities and target proficiency levels. The server executes these rules by iterating over missing or insufficient capabilities and mapping them to qualitative goal information. For example, if job-requirement information indicates that a role “project lead” requires “leadership” at level 3 and the user's current capability is level 1, the server generates a qualitative goal such as “improve leadership skills from level 1 to level 3 by participating in leadership training and leading subprojects.” The server stores each qualitative goal as a record including a goal identifier, a textual description, and metadata such as priority and time horizon.

The server acquires regulation information related to work from both external and internal information sources. The server can invoke an external API provided by a regulation data service by sending HTTPS requests with parameters such as jurisdiction and industry code.

The server receives JSON data describing applicable laws, articles, and compliance obligations. The server also queries an internal regulation database that caches or augments this information. The server parses the regulation information using a parsing module that extracts key attributes such as regulation identifier, effective date, and required actions. The server applies rule-based mapping logic that transforms each regulation obligation into goal information in consideration of regulation compliance. For example, when a regulation describes a mandatory yearly training, the server creates a goal such as “complete mandatory data-protection training by the end of Q3.” The server stores these regulation-compliance goals in a dedicated table and associates them with a user or a machine identifier.

The server integrates numeric goal information, qualitative goal information, and goal information in consideration of regulation compliance into an integrated goal data structure. The integrated goal data structure can be implemented as a composite object that references underlying table records through keys and includes aggregated fields such as goal category, related metrics, and target period. The server maintains this integrated structure in memory to avoid repeated database lookups when constructing a prompt sentence. The integrated structure also includes flags indicating which goals are user-adjustable and which goals are mandatory due to regulation, which later prevents the generative AI model and adjustment logic from violating compliance constraints.

The server constructs a prompt sentence for a generative AI model in natural language by converting elements of the integrated goal data structure into concise text. The server uses a template-based formatter that inserts numeric values, skill-gap descriptions, and compliance obligations into predefined patterns. In one example, the server generates the following prompt sentence:
“Previous period target: 1,000,000 JPY, actual performance: 1,200,000 JPY (20% above target). Propose next period's numeric sales goal and qualitative goals for leadership improvement and compliance with data-protection regulations. Consider realistic workload.”

In another example, the server generates a prompt sentence for a factory robot as:
“Using the past performance data of the assembly robot (average 500 units per hour, 2% defect rate), set numeric targets for the next quarter, including throughput and defect rate. Add qualitative goals to improve self-diagnostics and to comply with factory safety standards. The robot's current condition indicates high stress, so moderate the throughput target and include scheduled maintenance actions.”

These prompt sentences are not merely human-crafted texts. The server constructs them programmatically from underlying structured data using deterministic template selection and substitution procedures. This reduces manual prompt engineering, ensures that critical numeric values and constraints are always included, and thereby improves reproducibility and consistency of AI call behavior.

The server transmits request information including the prompt sentence to the generative AI model over the communication interface. The generative AI model, in one implementation, is a neural network language model such as a transformer-based network. The transformer network uses multiple layers of self-attention and feedforward components. Each layer computes attention weights over tokens and applies linear transformations followed by non-linear activation functions. The model parameters include millions or billions of weights stored in model memory. The model has been trained offline using a corpus of text that includes instructions and examples of goal descriptions.

During inference, the generative AI model receives the prompt sentence tokenized into subword units and encoded as vectors. The model iteratively computes probability distributions over possible next tokens and samples or selects the most probable continuation under configured temperature and top-k/top-p parameters. The model thus generates natural-language text representing target-management proposal information. The server receives the generated text as response information via a network protocol such as HTTPS and extracts the text field from the response payload.

The server parses the generated text using a natural language processing module that segments it into parts corresponding to numeric goals, qualitative goals, and compliance-related recommendations. The server uses pattern matching such as list markers and headings, as well as keyword detection such as “Numeric goal”, “Qualitative goal” or “Compliance,” to map segments of text back to the integrated goal data structure. For each segment, the server updates relevant fields or attaches additional annotations. This transformation from unstructured text back to structured data is essential because it allows the server to further process, store, and propagate goals without human intervention, improving automation and reducing data-entry errors.

The terminal receives the integrated goal data structure and the human-readable text from the server. The terminal renders the goals on the display, showing numeric targets, qualitative self-development items, and compliance tasks in separate sections. The terminal, in some embodiments, displays tooltips that explain how the goals were derived, including references to growth rate and regulation rules. The terminal allows the user to enter free-text comments or adjust sliders that indicate whether the user wants more challenge or less workload. The terminal sends this feedback back to the server as opinion information and preference information.

The server receives opinion information and preference information via an API endpoint. The server runs a natural language processing pipeline on the text feedback. The pipeline tokenizes and normalizes the text, applies a part-of-speech tagger, and uses a classifier model such as a small transformer or recurrent neural network trained to detect intents like “increase target,” “decrease target,” “extend deadline,” or “add new skill area.” The server extracts numeric goal adjustment request information when the user specifies a percentage change, and qualitative goal adjustment request information when the user mentions new skill areas or qualitative changes. Because the server executes machine learning-based intent classification rather than simple keyword matching, the system can interpret nuanced language and reduce misclassification compared with simple rule-only approaches.

In embodiments with emotion processing, the terminal collects facial information, voice information, and biological information. The terminal uses a camera to capture facial images at a limited rate, such as one frame per second during the goal review interaction. The terminal downsamples the images and performs basic face detection to crop the face region, then transmits either image frames or extracted features to the server. The terminal also records short audio segments of the user's speech, extracts spectrograms or Mel-frequency cepstral coefficients, and sends these as numerical arrays. The terminal may retrieve biological information such as heart rate from a connected wearable sensor and transmit these in a compact format.

The server executes an emotion estimation model on the received multimodal data. In one implementation, the emotion estimation model is comprised of a convolutional neural network for facial expression classification, a recurrent neural network or 1-D convolutional network for speech emotion recognition, and a feedforward network for biological signal interpretation. Each sub-model outputs probability distributions over emotion classes such as “neutral,” “stressed,” “excited,” and “fatigued.” The server fuses these outputs using a weighted averaging scheme or a small ensemble model to produce emotional state information. The model parameters are trained offline using supervised learning. During training, the server or a separate training platform uses a labeled training set containing image, audio, and biosignal samples annotated with emotion labels. The training process minimizes a cross-entropy loss function by updating model weights using gradient descent or a variant such as Adam optimization. The server stores the trained model in the storage devices and loads it into memory during runtime. This explicit training structure and loss definition provides a reproducible and technically grounded basis for emotion estimation.

The server integrates emotional state information with opinion information. For example, when the user text states “this target is too high” and the emotion estimation model outputs “stressed,” the server sets an internal flag indicating that a decrease in numeric targets is appropriate. When the user text says “I want to challenge myself” and the emotion estimation model outputs “excited,” the server sets a flag indicating that moderate increases may be safe and motivating. The server then executes an adjustment process that adjusts numeric goal information and qualitative goal information. The adjustment process includes rules such as limiting changes to a defined range (for example, ±10%) to avoid instability, and ensuring that compliance goals are not removed or weakened. The server updates the integrated goal data structure accordingly and logs the old and new values along with reasons and emotion labels. These logs enable later auditing and can be stored in a log index such as in a search engine system.

The server constructs a second prompt sentence that includes both the adjusted goal information and the emotional state information. For example, the server can generate:

“The user initially received a proposed 20% increase but reported high stress and asked to reduce the target to 10%. Revise the goals and provide a balanced plan, including stress-management actions.”

The server sends this second prompt sentence to the generative AI model. The generative AI model processes this context and generates refined narrative text that typically explains the new target values, suggests coping strategies, and proposes well-structured action plans. The server converts this refined text into structured form and updates the integrated goal data structure again. This iterative prompt construction and refinement enables the use of the generative AI model as a component that can be driven by programmatically constructed input and can provide machine-usable output, rather than as an external manual assistant.

The server uses the final integrated goal data structure to generate operation condition information or work plan information for industrial apparatuses or information processing apparatuses. In an industrial scenario, the server maps numeric productivity targets and quality constraints to machine parameters such as cycle time, feed rate, or shift allocation.

The server then sends these parameters via protocols such as OPC UA or MQTT to machine controllers or edge gateways. The industrial apparatuses receive the operation condition information and update their operation plans automatically. For example, a production robot may adjust its planned throughput or insert additional inspection cycles based on updated quality targets. This propagation of AI-derived goals into machine control is not limited to simple automation of human-planned targets; rather, it allows dynamic adjustments anchored in combined performance data, capability analysis, regulation compliance, and emotional state of human operators. This improves technical efficiency by reducing downtime, preventing overload, shortening feedback loops, and continuously tuning control parameters.

The server periodically re-executes the sequence of data acquisition, goal computation, prompt construction, AI invocation, and goal adjustment. In one example, the server triggers a re-evaluation each week or at the beginning of each quarter. The server executes batch jobs that read updated performance tables, update regulation information caches, refresh capability information, and analyze time-series of emotional state. This periodic processing ensures that goal information remains synchronized with evolving conditions. Because the server maintains integrated goal data structures and associated logs, it can avoid recomputing all intermediate results from scratch, and can instead perform incremental updates, which reduce computation time and storage bandwidth.

This architecture and processing pipeline improve computer technology beyond simple automation of manual goal setting. The server uses specific data structures (tables, integrated goal objects), specific numerical algorithms (vectorized growth and achievement calculations), specific machine learning algorithms (transformer-based generative model, CNN/RNN-based emotion model, intent classifier), and specialized prompt-construction procedures. The integration of these components enables an automated, closed-loop controller for both human-centered and machine-centered goals that is not feasible with human manual adjustments alone. The system reduces latency in recalculating valid goals, reduces error by consistently incorporating regulation constraints and emotional conditions, and improves computational efficiency by using structured data and vectorized operations.

The server also reduces communication load by sending only changed parameters to industrial apparatuses, and by encoding emotion features compactly.

The AI-based components operate according to rules and procedures that are not simple reproductions of human judgment. For instance, the emotion estimation model fuses multimodal signals using learned weights that are optimized to minimize a defined loss function over large datasets. The generative AI model, when driven by prompt sentences including both numeric data and categorical flags, implements a mapping between data conditions and textual output that is difficult for humans to perform consistently and quickly.

The rule engine for compliance mapping ensures that legal constraints are always encoded as non-removable goal components, which prevents the model from proposing non-compliant objectives. This combination of algorithmic learning, rule-based constraints, and structured data transformation results in technical effects such as improved accuracy of goal alignment with real-world constraints, reduced number of manual iterations needed for goal negotiation, and reduced risk of configuration errors in controlled apparatuses.

In alternative embodiments, the server may use different database engines, different model architectures, or different communication protocols. For example, the server may use a column-oriented database instead of a row-oriented one to further accelerate aggregate computations, or may use a recurrent network or encoder-decoder architecture as the generative AI model. The server may deploy the emotion estimation model on the terminal instead of the server to reduce network load when bandwidth is limited. The server may also use a different error function, such as a margin-based loss, to train the emotion estimation model for certain application domains. The central concept remains that the server programmatically constructs prompt sentences from integrated goal data, invokes a generative AI model to obtain proposal information, converts the result back into structured data, and adjusts goals using user feedback and emotional state in a way tightly coupled with machine-controlling outputs.

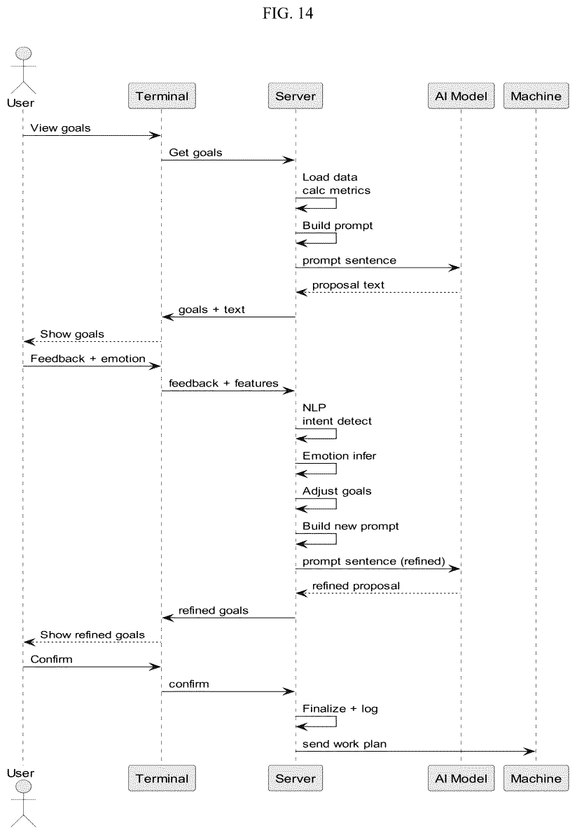

The following describes the processing flow using FIG. 14.

### Step 1:

The server acquires previous period target information and current performance information from a storage device. As input, the server receives a user identifier or apparatus identifier and a time-period identifier. The server executes SQL queries on a relational database to read records containing target values and actual performance values. The server then loads the query results into an in-memory data-frame structure. The server performs data cleansing by removing invalid records and converting data types to numeric formats, and outputs a normalized data frame containing aligned previous period targets and current performance values.

### Step 2:

The server calculates growth rate information and achievement rate information. As input, the server uses the normalized data frame containing previous targets and current performance values. The server applies vectorized numerical operations using a numerical library to compute, for each record, a growth rate as (current_actual−previous_actual)/previous_actual and an achievement rate as current_actual/previous target. The server rounds results to predetermined precision and handles division-by-zero cases by inserting default values. The server outputs an updated data frame with additional columns for growth_rate and achievement_rate.

### Step 3:

The server acquires capability information and job-path information of a user. As input, the server receives a user identifier from the terminal or from a scheduled job. The server issues SQL queries to user-profile tables to retrieve skills, proficiency levels, certifications, past roles, and desired future roles. The server converts these into internal objects or data frames, applies normalization of skill names, and maps them to standardized capability identifiers.

The server outputs a capability profile and a job-path profile for the user.

### Step 4:

The server compares capability information with job-requirement information and sets qualitative goal information for self-development. As input, the server uses the capability profile, the job-path profile, and a job-requirement table that lists required skills and target levels for each role. The server executes a rule engine that iterates over required capabilities for the target role, computes differences between required levels and current levels, and identifies gaps. The server performs data processing that transforms each gap into a qualitative goal description, for example “increase leadership skill from level 1 to level 3 within 6 months.” The server outputs a list of qualitative goal records linked to the user.

### Step 5:

The server acquires regulation information related to work and sets goal information in consideration of regulation compliance. As input, the server receives jurisdiction and industry information associated with the user or apparatus. The server sends HTTP requests to an external regulation API and queries an internal regulation cache database to obtain relevant laws and rules. The server parses JSON or other structured responses, extracts obligations and deadlines, and applies mapping rules that convert each obligation into a compliance goal, such as “complete annual safety training before [date].” The server outputs a list of compliance goal records associated with the user or apparatus.

### Step 6:

The server integrates numeric goal information, qualitative goal information, and compliance goal information into an integrated goal data structure. As input, the server uses the data frame containing growth and achievement rates, the list of qualitative goals, and the list of compliance goals. The server applies data-joining operations based on common keys such as user identifier and period, and constructs a composite object that contains all goals categorized by type, priority, and time horizon. The server performs consistency checks to ensure that identifiers are unique and that mandatory compliance goals are flagged as non-removable. The server outputs a unified integrated goal structure residing in memory.

### Step 7:

The server constructs a prompt sentence for a generative AI model in natural language. As input, the server uses the integrated goal structure that contains numeric targets, qualitative gaps, and compliance constraints. The server applies a template-selection algorithm that chooses a template based on user role and apparatus type, then fills template slots with concrete values from the integrated structure. The server concatenates text segments with correct punctuation and units, thereby generating a coherent prompt sentence such as “Previous period target: 1,000,000 JPY, actual performance: 1,200,000 JPY (20% above target). Propose next period's numeric sales goal and qualitative goals for leadership improvement and compliance with data-protection regulations.” The server outputs the constructed prompt sentence as a text string.

### Step 8:

The server sends the prompt sentence to the generative AI model and receives target-management proposal information. As input, the server uses the prompt sentence and optional configuration parameters such as model name and temperature. The server creates a request payload, transmits it to a generative AI endpoint over HTTPS, and waits for a response. The generative AI model processes the prompt and returns generated text. The server receives the response JSON, extracts the generated text field, and performs basic postprocessing such as trimming whitespace. The server outputs a natural-language target-management proposal string.

### Step 9:

The server parses the target-management proposal string and converts it into structured data. As input, the server uses the generated natural-language proposal text. The server applies natural language processing, including sentence segmentation and pattern matching, to detect sections describing numeric targets, qualitative objectives, and compliance recommendations.

The server extracts numeric values from text using regular expressions and maps them to corresponding goal fields. The server also maps recognized phrases to goal categories. The server outputs an updated integrated goal structure that now includes structured values derived from the generative AI output.

### Step 10:

The server sends the generated goals and explanation text to the terminal. As input, the server uses the updated integrated goal structure and a narrative summary text. The server formats a response message containing structured goals and descriptive fields and sends it over a network connection to the terminal. The server outputs a response packet that the terminal can render in a user interface.

### Step 11:

The terminal displays the goals to the user and acquires user feedback. As input, the terminal receives the structured goal data and narrative summary from the server. The terminal renders a screen with sections for numeric targets, qualitative self-development goals, and compliance tasks, and shows explanations in readable text. The terminal presents input fields and controls, allowing the user to type comments or adjust preference sliders. The terminal outputs user-entered opinion information and preference information as local data ready for transmission.

### Step 12:

The user reviews the goals and inputs feedback. As input, the user observes the goals and explanations displayed on the terminal screen. The user cognitively evaluates whether targets are realistic or challenging and then types free-text comments, such as “reduce the increase to 10% and add a goal for presentation skills,” or selects options such as “more challenging” or “lighter workload.” The user may also speak a short comment if voice input is enabled. The user outputs opinion information and preference information to the terminal.

### Step 13:

The terminal transmits opinion information and preference information to the server. As input, the terminal uses the user-entered text and any selected options. The terminal packages this information into a request message, including identifiers linking it to the current goal set, and sends it over HTTPS to the server. The terminal outputs a feedback payload containing raw feedback text and preference markers.

### Step 14:

The terminal acquires emotional signals from the user when available. As input, the terminal receives a signal to start emotion capture when the user is viewing goals. The terminal uses a camera to capture facial images, a microphone to capture voice while the user speaks comments, and sensors or external devices to read biological signals such as heart rate. The terminal performs basic preprocessing, such as resizing images and computing audio features, to reduce data size. The terminal outputs a set of visual features, audio features, and biological measurements ready to be sent to the server.

### Step 15:

The terminal transmits emotional features to the server. As input, the terminal uses the preprocessed facial, voice, and biological features. The terminal inserts timestamps and user identifiers, and sends these feature vectors to the server via a secure network channel. The terminal outputs an emotion-feature payload associated with the corresponding feedback session.

### Step 16:

The server performs natural language processing on the opinion information and preference information to extract adjustment requests. As input, the server receives the feedback payload including text and preference flags. The server tokenizes the text, normalizes words, and applies an intent-classification model to detect user intentions such as “decrease numeric goal,” “increase numeric goal,” “extend deadline,” or “add new qualitative goal.” The server extracts numeric goal adjustment request information by identifying numbers and percentage expressions, and extracts qualitative goal adjustment request information by identifying new skill or topic mentions. The server outputs a structured adjustment-request object that encodes desired changes.

### Step 17:

The server computes emotional state information from the emotional features. As input, the server uses the feature payload containing visual, audio, and biological signals. The server feeds these features into pre-trained submodels, such as a convolutional neural network for facial expressions, a recurrent neural network for speech features, and a feedforward network for biological signals. Each submodel outputs probabilities for emotion classes. The server combines the outputs using a fusion algorithm, such as weighted averaging, to produce a single emotional state vector. The server selects the highest probability class as the current emotional state and computes a confidence score. The server outputs emotional state information including an emotion label and confidence.

### Step 18:

The server performs an adjustment process on numeric and qualitative goals based on feedback and emotional state. As input, the server uses the integrated goal structure, the adjustment-request object, and the emotional state information. The server applies decision rules that, for example, reduce target growth if the user requested a reduction and is in a stressed state, or slightly raise targets if the user requested a challenge and is in an excited state. The server clamps adjustments within predefined bounds to avoid extreme values, and ensures that regulation-based goals remain unchanged. The server updates numeric target fields and qualitative goal descriptions as required. The server outputs a revised integrated goal structure reflecting adjusted goals.

### Step 19:

The server constructs a second prompt sentence including adjusted goals and emotional context. As input, the server uses the revised integrated goal structure and the emotional state information. The server selects a refinement template and inserts updated numeric values, qualitative items, and a short description of the user's emotional state. The server generates a prompt sentence such as “The user initially received a 20% increase but reported high stress and requested a reduction to 10%. Revise the goals and provide a balanced plan, including stress-management actions.” The server outputs this second prompt sentence text.

### Step 20:

The server sends the second prompt sentence to the generative AI model and receives a refined proposal. As input, the server uses the second prompt sentence together with model configuration parameters. The server constructs a new request message and sends it to the generative AI endpoint. The generative AI model returns refined text that describes adjusted numeric targets, qualitative goals, and suggested actions. The server receives and parses this response into sections similarly to the first call. The server outputs an updated narrative proposal aligned with the adjusted structured goals.

### Step 21:

The server synchronizes the refined proposal with the integrated goal structure. As input, the server uses the revised structured goals and the refined narrative text. The server checks for any discrepancies between values mentioned in text and values stored in structure, and, if differences exist within a tolerance, reconciles them by updating annotations. The server stores the final version of structured goals and narrative explanation in the database. The server outputs a finalized goal package ready for confirmation and deployment.

### Step 22:

The server transmits the finalized goals to the terminal for confirmation. As input, the server uses the finalized goal package. The server prepares a response message with structured fields and narrative explanation and sends it over the network to the terminal. The server outputs a confirmation message containing all finalized goals and related descriptions.

### Step 23:

The terminal displays the finalized goals and prompts the user for confirmation. As input, the terminal receives the confirmation message. The terminal renders the updated numeric and qualitative targets and highlights changes from the previous version. The terminal shows the narrative that explains why targets were changed, including mentions of stress reduction or increased challenge. The terminal presents options such as “Confirm” and “Request minor change.” The terminal outputs the user's final choice and any short comment.

### Step 24:

The user confirms or rejects the finalized goals. As input, the user reads the displayed goals and narrative explanation. The user selects the confirmation option if the goals are acceptable or types a brief additional request if a minor modification is needed. The user's selection is captured by the terminal interface. The user outputs a final confirmation response.

### Step 25:

The terminal transmits the final confirmation response to the server. As input, the terminal uses the user's selection and any optional comment. The terminal sends this confirmation message to the server via the established API. The terminal outputs a confirmation payload indicating acceptance or further requested change.

### Step 26:

The server finalizes and logs the confirmed goals. As input, the server receives the confirmation payload. The server sets the status of the integrated goal structure to “confirmed” in the database, records a timestamp, and stores audit information including the final values, user feedback history, and emotional state summaries. The server also logs configuration details such as which models and rules were applied. The server outputs a confirmed goal set and a log record.

### Step 27:

The server generates operation condition information or work plan information for industrial apparatuses or information processing apparatuses based on the confirmed goals. As input, the server uses the confirmed integrated goal structure. The server applies mapping rules that translate numeric targets into apparatus-specific parameters, such as production quotas, cycle times, or resource allocations. The server constructs work plans as schedules and tasks and encodes them into messages formatted for industrial protocols. The server outputs apparatus-specific operation condition information and work plan information.

### Step 28:

The server transmits operation condition information and work plan information to industrial apparatuses or information processing apparatuses. As input, the server uses the apparatus-specific control messages. The server sends these messages via communication interfaces supporting protocols such as OPC UA, Modbus/TCP, or MQTT. The industrial apparatuses receive these messages and update their internal control registers or schedules. The server outputs a confirmation of successful transmission or error codes if communication fails.

### Step 29:

The server periodically re-evaluates goals based on new performance and emotional data. As input, the server uses scheduled triggers and updated performance records, regulation updates, capability updates, and aggregated emotional histories. The server repeats Steps 1 through 28 with the new data, performing incremental computations where possible to reduce processing load. The server outputs updated goals, new prompt sentences, and adjusted operation plans over time, thereby maintaining a continuous adaptive control loop.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

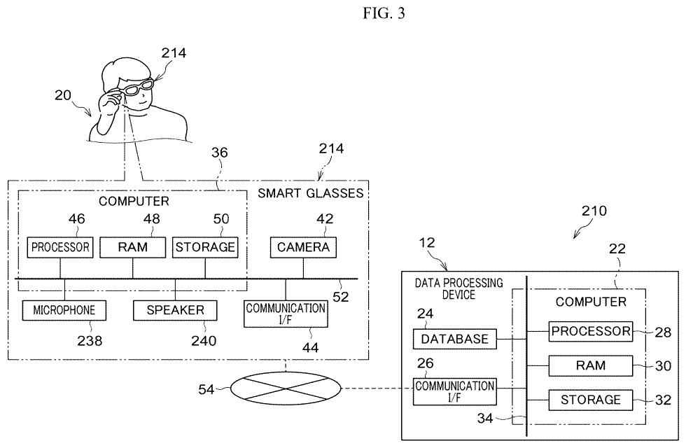

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

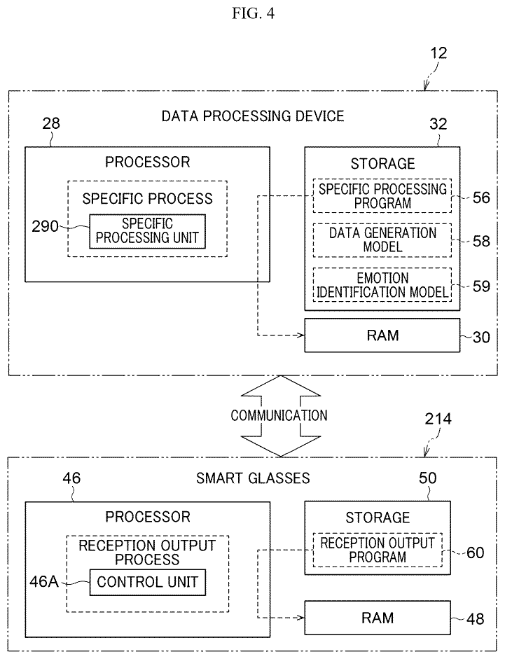

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

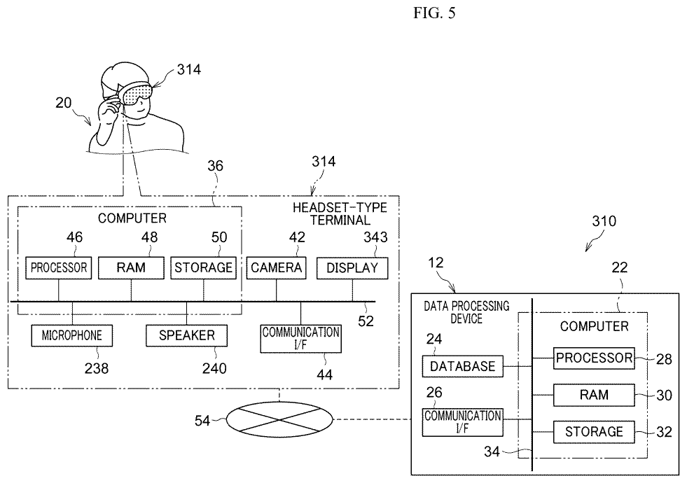

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

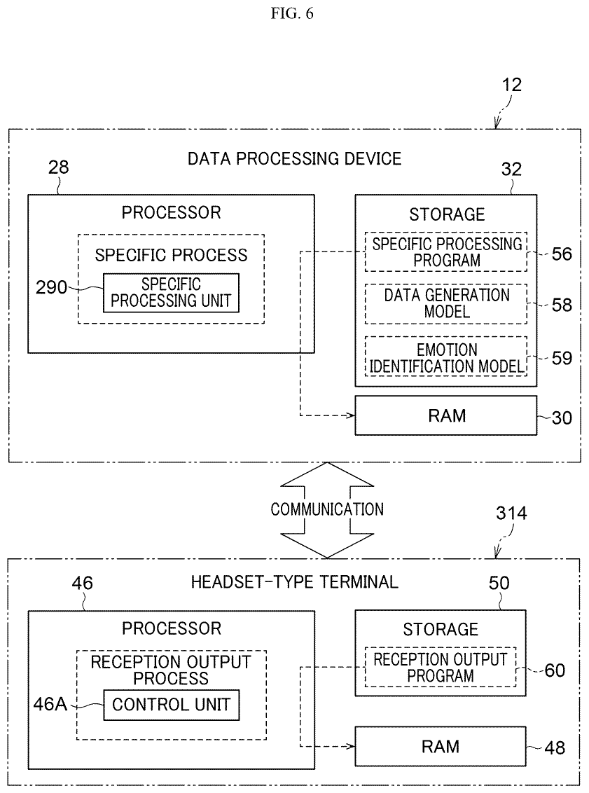

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

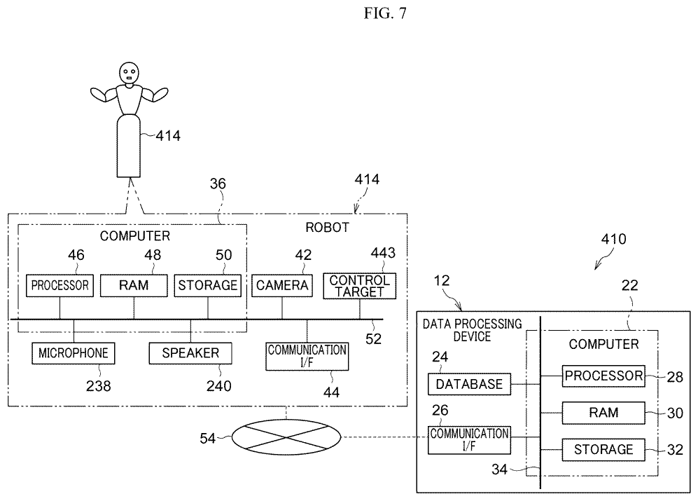

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

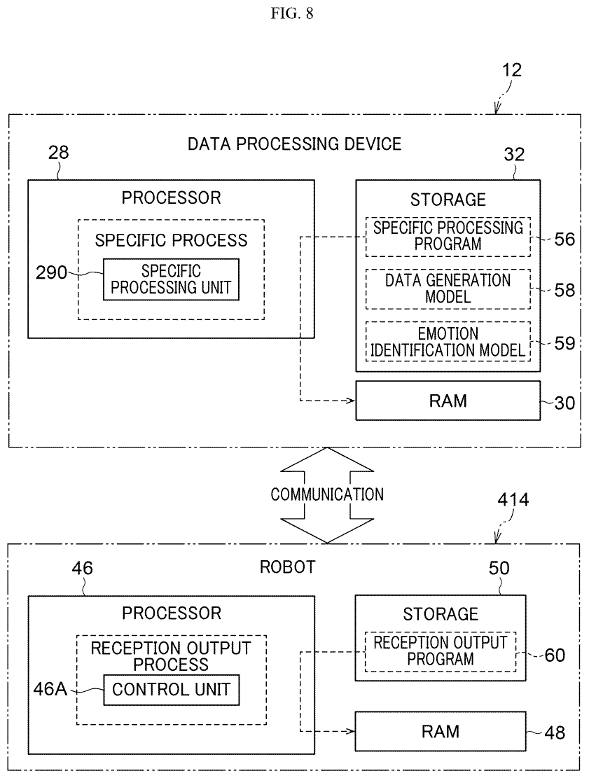

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

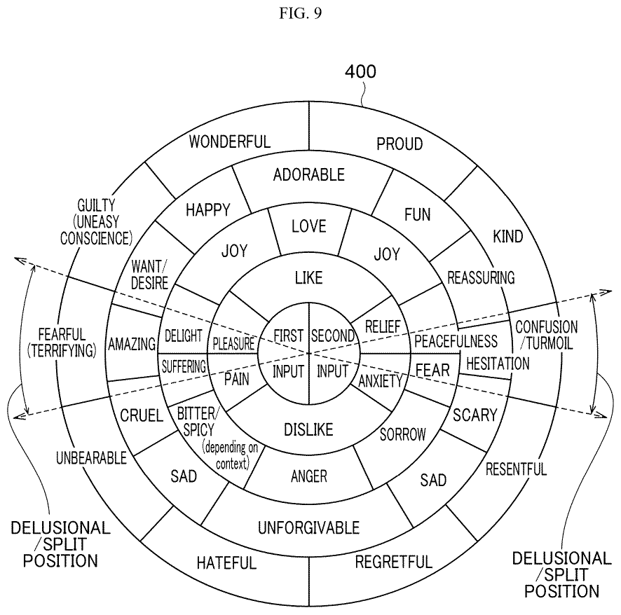

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

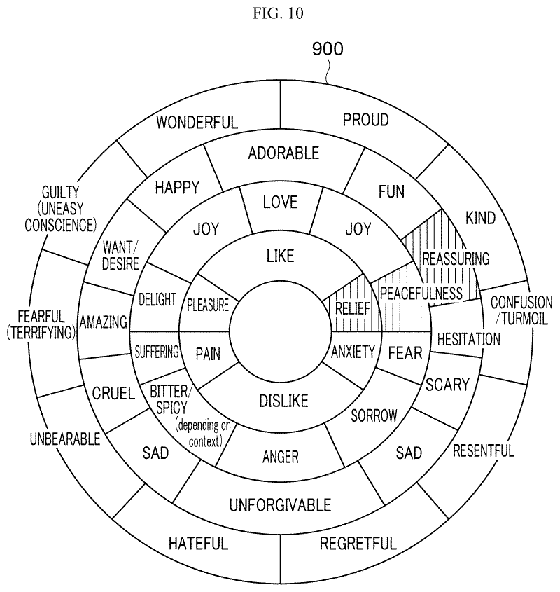

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire previous-term target information and current performance information as structured information stored in an information storage device, extract the information by using an information retrieval language, hold the extracted information as tabular information by using an information analysis library, execute arithmetic operations on the tabular information to calculate numerical indicators including a growth rate and an achievement rate, and
automatically set a numerical target based on the numerical indicators,
acquire, as natural language information, skill set information, career path information, and evaluation information of a user that are input from a terminal device, segment and annotate the natural language information by using a natural language processing library, extract phrases relating to skills and phrases relating to career orientation, and set, as structured information, a qualitative target for self-development based on the extracted phrases,
transmit a request signal to an external statute information providing apparatus by using a communication protocol, acquire statute information related to work as machine-readable information, extract compliance items from the statute information, and set, as structured information, a compliance target based on the extracted compliance items,
generate integrated target information by integrating the numerical target, the qualitative target, and the compliance target, summarize and classify the integrated target information, and generate a target generation instruction text that constitutes a prompt sentence to be used as input to a generative information generation model,
input the prompt sentence to the generative information generation model, acquire natural language text including an MBO target proposal corresponding to the integrated target information, and hold the natural language text as proposal information,
estimate an emotional state of the user based on behavior information, input operation information, or biometric-related information acquired from the user, and adjust at least one of a target value and a deadline of the numerical target and the qualitative target in accordance with the emotional state, and
output the proposal information and adjusted target information to the terminal device, and enable the integrated target information and the prompt sentence to be regenerated based on feedback information obtained through interaction with the user.

### (Supplementary 2)

The system according to supplementary 1,
wherein the processor is configured to
set the numerical target by using the growth rate and the achievement rate that are automatically calculated by the information analysis library based on a comparison between the previous-term target information and the current performance information, and further correct a level or a deadline of the numerical target in accordance with an estimation result of the emotional state.

### (Supplementary 3)

The system according to supplementary 1,
wherein the processor is configured to
regenerate the MBO target proposal by updating contents of the prompt sentence input to the generative information generation model based on feedback information acquired from interaction with the user and the estimation result of the emotional state, thereby enabling at least a part of the numerical target, the qualitative target, and the compliance target to be dynamically changed.

### Application Example 1

### (Supplementary 1)

A system comprising a processor and a storage device,
wherein the processor is configured to
obtain operation information of production equipment from the storage device that stores past operation information, compare previous-period target information with current performance information, calculate growth-rate information and achievement-rate information, and
automatically set numerical target information for a next period of the production equipment based on the growth-rate information and the achievement-rate information,
obtain user attribute information including skill information, career information, and
evaluation information from the storage device that stores user attribute information, and set qualitative target information for self-improvement based on the user attribute information, obtain regulation information including law information and rule information from the storage device that stores business-related regulation information, and set compliance target information based on the regulation information,
integrate the numerical target information, the qualitative target information, and the compliance target information to generate integrated target information, and generate prompt-sentence information for input to a generative information processing model based on the integrated target information, the operation information, and the user attribute information, transmit the prompt-sentence information to an external information processing service,
receive target-candidate information output by the generative information processing model from the external information processing service, and automatically generate target-management information including the target-candidate information,
transmit the automatically generated target-management information to a terminal device, and update the target-management information based on modification information received from the terminal device from a user, and
obtain state information of the user and adjust at least one of the numerical target information and the qualitative target information based on the state information.

### (Supplementary 2)

The system according to supplementary 1,
wherein the processor is configured to
execute table-format information processing in an arithmetic-processing program execution environment to aggregate the past operation information, calculate the growth-rate information and the achievement-rate information based on the aggregated past operation information, automatically set the numerical target information based on calculation results, and increase or decrease a target value of the numerical target information in accordance with the state information.

### (Supplementary 3)

The system according to supplementary 1,
wherein the processor is configured to
cause the terminal device to present the automatically generated target-management information to the user, and dynamically update the target-management information including the target-candidate information from the generative information processing model based on interaction-operation information with the user at the terminal device and based on the state information.

### Example 2

### (Supplementary 1)

A system comprising a processor,
wherein the processor is configured to
acquire history information including previous-period goal information and current performance information, and calculate growth-rate information and achievement-rate information on the basis of the history information,
acquire user information including user attribute information and job information, and set qualitative-goal information for self-development on the basis of the user information, acquire norm information including statute information related to work and internal rule information, and set compliance-goal information on the basis of the norm information, automatically set numerical-goal information including comparison conditions with a previous period on the basis of the growth-rate information and the achievement-rate information,
integrate the numerical-goal information, the qualitative-goal information, and the compliance-goal information, and generate a prompt sentence for automatically generating management-by-objectives goal proposal information based on a goal-management method,
input prompt-sentence information including a user input sentence acquired via a terminal into a generative AI model, and cause the generative AI model to analyze the prompt-sentence information and automatically generate MBO goal proposal information including the numerical-goal information, the qualitative-goal information, and the compliance-goal information,
perform document-generation processing by using the generative AI model so as to convert the MBO goal proposal information into goal-document information in natural language,
associate user-feedback information acquired via the terminal with the MBO goal proposal information and the prompt-sentence information, generate revision-prompt-sentence information including the user-feedback information, and input the revision-prompt-sentence information into the generative AI model so as to dynamically regenerate the MBO goal proposal information,
analyze emotion-state information of the user, and adjust the numerical-goal information and the qualitative-goal information on the basis of the emotion-state information and the user-feedback information, and
hold the MBO goal proposal information and version-management information thereof as record information, and output finalized MBO goal information to another business-processing system.

### (Supplementary 2)

The system according to supplementary 1,
wherein the processor is configured to
generate the prompt-sentence information to be input to the generative AI model as structured information obtained by integrating a plurality of kinds of information including the history information, the user information, the norm information, and the user-feedback information, and cause the generative AI model to simultaneously extract and reconstruct the numerical-goal information, the qualitative-goal information, and the compliance-goal information on the basis of the structured information.

### (Supplementary 3)

The system according to supplementary 1,
wherein the processor is configured to
sequentially update the revision-prompt-sentence information in response to a plurality of items of user-feedback information sequentially input from the terminal, sequentially present the MBO goal proposal information generated by the generative AI model while performing version management of the MBO goal proposal information, and dynamically adjust the MBO goal proposal information on the basis of the emotion-state information and dialogue-history information.

### Application Example 2

### (Supplementary 1)

A system comprising a processor,
wherein the processor is configured to
acquire previous period target information and current performance information, and calculate growth rate information and achievement rate information by performing numerical computation processing,
acquire capability information and job-path information of a user, and set qualitative goal information for self-development based on a comparison between the capability information and job-requirement information,
acquire regulation information related to work from an external information source or an internal information source, and set goal information in consideration of regulation compliance based on content analysis of the regulation information,
integrate numeric goal information based on the growth rate information and the achievement rate information, the qualitative goal information, and the goal information in consideration of regulation compliance, and construct, in a natural language, a prompt sentence for inputting the integrated goal information as input conditions to a generative artificial intelligence model,
transmit request information including the prompt sentence to the generative artificial intelligence model, acquire response information including target-management proposal information from the generative artificial intelligence model, and store the response information as structured data,
receive opinion information and preference information regarding the target-management proposal from the user via a terminal device, and extract numeric goal adjustment request information and qualitative goal adjustment request information by performing natural language processing on the opinion information and the preference information,
calculate emotional state information of the user by using an emotion estimation model based on facial information, voice information, or biological information acquired from the terminal device, and execute an adjustment process for increasing or decreasing, or changing content of, at least one of the numeric goal information and the qualitative goal information by integrally evaluating the emotional state information and the opinion information,
generate, again, a prompt sentence including goal information after the adjustment process and the emotional state information, input the prompt sentence to the generative artificial intelligence model, and thereby cause the generative artificial intelligence model to generate a revised version of the target-management proposal information so as to output goal information dynamically updated according to the emotional state and feedback of the user, and
transmit, to an industrial apparatus or an information processing apparatus, operation condition information or work plan information based on the dynamically updated goal information via a communication network, and update an operation plan of the industrial apparatus or the information processing apparatus.

### (Supplementary 2)

The system according to supplementary 1,
wherein the processor is configured to cause the terminal device to display the target-management proposal information generated by the generative artificial intelligence model and the goal information after the adjustment process to the user, receive confirmation information or additional feedback information from the user, and perform goal-information finalization processing and history-recording processing based on the confirmation information or the additional feedback information.

### (Supplementary 3)

The system according to supplementary 1,
wherein the processor is configured to periodically reacquire the performance information, the regulation information, the capability information, and the emotional state information, and repeatedly execute generation of the prompt sentence, generation of the target-management proposal information by the generative artificial intelligence model, the adjustment process, and updating of the operation plan of the industrial apparatus or the information processing apparatus, thereby performing continuous and adaptive target management.

What is claimed is:

1. A system comprising:
circuitry configured to:
receive, via a communication interface coupled to a packet-switched network, natural language input data and behavior data from a terminal device;
retrieve, from a storage device using an information retrieval language, tabular data comprising prior-period indicator values and current measurement values, execute arithmetic operations on the tabular data to compute numerical indicators comprising a growth rate and an achievement rate, and derive a first target parameter based on the numerical indicators;
apply a natural language processing library to the natural language input data to perform segmentation and annotation, extract phrases associated with capability attributes and orientation attributes, and derive a second target parameter based on the extracted phrases;
transmit a request signal to an external information source via the communication interface to acquire machine-readable regulation data, extract compliance items from the regulation data, and derive a third target parameter based on the extracted compliance items;
generate integrated target information by combining the first target parameter, the second target parameter, and the third target parameter, and construct a prompt sentence encoding the integrated target information for input to a generative neural network model;
input the prompt sentence to the generative neural network model to generate natural language proposal text, and store the proposal text in the storage device as proposal information; and
estimate an emotional state of the user from the behavior data and at least one of input operation data or biometric data received from the terminal device, and adjust at least one of a target value or a deadline parameter in the integrated target information based on the estimated emotional state.

2. The system according to claim 1, wherein the circuitry is configured to compute the growth rate by calculating a ratio of the current measurement values to the prior-period indicator values, and to compute the achievement rate by calculating a ratio of the current measurement values to a target indicator value stored in the storage device.

3. The system according to claim 2, wherein the circuitry is configured to derive the first target parameter by applying a threshold comparison to the growth rate and the achievement rate, and to set a target increment value proportional to a deviation of the growth rate from a reference growth rate stored in the storage device.

4. The system according to claim 2, wherein the first target parameter comprises a numerical objective based on performance data of a user, the second target parameter comprises a qualitative objective for self-development, and the third target parameter comprises a legal compliance objective based on statutory requirements related to a business operation.

5. The system according to claim 4, wherein the circuitry is configured to generate an MBO draft proposal as the natural language proposal text by encoding the numerical objective, the qualitative objective, and the legal compliance objective as structured fields in the prompt sentence, and inputting the prompt sentence to the generative neural network model.

6. The system according to claim 1, wherein the circuitry is configured to apply an emotion identification model to at least one of the behavior data, the input operation data, or the biometric data to generate a probability distribution over a plurality of emotional state categories, and to select an adjustment strategy for the integrated target information based on the probability distribution.

7. The system according to claim 6, wherein the circuitry is configured to determine, when the probability distribution indicates a stress-associated emotional state, to reduce a target increment value in the first target parameter and to extend a deadline parameter in the second target parameter, and to regenerate the prompt sentence based on the adjusted integrated target information.

8. The system according to claim 1, wherein the circuitry is configured to apply the natural language processing library to the natural language input data by performing tokenization, part-of-speech tagging, and named entity recognition to identify skill-related phrases and orientation-related phrases, and to map the identified phrases to structured attribute fields used to derive the second target parameter.

9. The system according to claim 8, wherein the circuitry is configured to extract the phrases associated with capability attributes by applying a phrase classification model that assigns each segmented phrase a capability relevance score, and to select phrases exceeding a capability relevance threshold as inputs to the second target parameter derivation.

10. The system according to claim 1, wherein the circuitry is configured to transmit the request signal to the external information source by constructing a protocol-specific query encoding a work category identifier derived from the natural language input data, and to parse the acquired machine-readable regulation data to extract compliance requirement identifiers.

11. The system according to claim 10, wherein the circuitry is configured to derive the third target parameter by mapping each compliance requirement identifier to a structured compliance target field, and to associate each compliance target field with a validity period extracted from the machine-readable regulation data.

12. The system according to claim 1, wherein the circuitry is configured to regenerate the prompt sentence and the natural language proposal text after adjustment of the integrated target information, and to transmit updated proposal information comprising the adjusted integrated target information and the regenerated natural language proposal text to the terminal device via the communication interface.

13. The system according to claim 12, wherein the circuitry is configured to store a history of prompt sentences and corresponding natural language proposal texts in the storage device, and to retrieve the history to augment a subsequent prompt sentence with prior iteration context.

14. The system according to claim 1, wherein the circuitry is configured to compute a composite indicator by applying a weighted aggregation to the growth rate, the achievement rate, and the numerical indicators, and to derive the first target parameter by applying a regression model to the composite indicator.

15. The system according to claim 1, wherein the circuitry is configured to generate the integrated target information by constructing a structured data record comprising the first target parameter, the second target parameter, and the third target parameter as distinct fields, and to summarize and classify the integrated target information into priority levels before constructing the prompt sentence.

16. The system according to claim 1, wherein the circuitry is configured to output the proposal information and the adjusted integrated target information to the terminal device, and to acquire revision instruction data from the terminal device, wherein the circuitry regenerates the prompt sentence incorporating the revision instruction data and inputs the regenerated prompt sentence to the generative neural network model to generate revised natural language proposal text.

17. The system according to claim 1, wherein the circuitry is configured to apply a retrieval-augmented generation pipeline by querying a vector database using an embedding vector derived from the integrated target information to retrieve reference documents, and incorporating the retrieved reference documents into the prompt sentence.

18. A system comprising:
circuitry configured to:
receive, via a communication interface coupled to a packet-switched network, natural language input data from a terminal device;
retrieve tabular data from a storage device using an information retrieval language, execute arithmetic operations on the tabular data to compute a growth rate and an achievement rate from prior-period indicator values and current measurement values, and derive a first target parameter based on the growth rate and the achievement rate;
apply a natural language processing library to the natural language input data to perform segmentation, annotation, and phrase extraction to derive a second target parameter comprising capability-oriented phrases and orientation-oriented phrases;
acquire machine-readable regulation data from an external information source via the communication interface, extract compliance requirement identifiers from the regulation data, and derive a third target parameter based on the extracted compliance requirement identifiers;
generate integrated target information by combining the first target parameter, the second target parameter, and the third target parameter, construct a prompt sentence encoding the integrated target information, and execute a generative neural network model using the prompt sentence to generate natural language proposal text; and
estimate an emotional state of a user from behavior data received from the terminal device, and adjust at least one of a target value or a deadline parameter in the integrated target information based on the estimated emotional state, and transmit the natural language proposal text and the adjusted integrated target information to the terminal device via the communication interface.

19. The system according to claim 18, wherein the circuitry is configured to apply an emotion identification model to the behavior data to generate an emotional state indicator, and to regenerate the prompt sentence and the natural language proposal text based on the adjusted integrated target information when the emotional state indicator satisfies an adjustment threshold.

20. A method comprising:
receiving, via a communication interface coupled to a packet-switched network, natural language input data and behavior data from a terminal device;
retrieving, from a storage device using an information retrieval language, tabular data comprising prior-period indicator values and current measurement values, executing arithmetic operations on the tabular data to compute numerical indicators comprising a growth rate and an achievement rate, and deriving a first target parameter based on the numerical indicators;
applying a natural language processing library to the natural language input data to perform segmentation and annotation, extracting phrases associated with capability attributes and orientation attributes, and deriving a second target parameter based on the extracted phrases;
transmitting a request signal to an external information source via the communication interface to acquire machine-readable regulation data, extracting compliance items from the regulation data, and deriving a third target parameter based on the extracted compliance items;
generating integrated target information by combining the first target parameter, the second target parameter, and the third target parameter, and constructing a prompt sentence encoding the integrated target information for input to a generative neural network model;
inputting the prompt sentence to the generative neural network model to generate natural language proposal text, and storing the proposal text in the storage device as proposal information; and
estimating an emotional state of the user from the behavior data and at least one of input operation data or biometric data received from the terminal device, and adjusting at least one of a target value or a deadline parameter in the integrated target information based on the estimated emotional state.
